(19) United States
(12) Patent Application Publication
(10) Pub. No.: US 2023/0408196 A1
(43) Pub. Date: Dec. 21, 2023

(54) VENEER DEWATERING APPARATUS AND METHOD OF DEWATERING VENEER

(71) Applicant: MEINAN MACHINERY WORKS, INC., Aichi (JP)

(72) Inventor: Shin-ichi SAKAMOTO, Obu-shi (JP)

(73) Assignee: MEINAN MACHINERY WORKS, INC., Aichi (JP)

(21) Appl. No.: 18/159,549

(22) Filed: Jan. 25, 2023

(30) Foreign Application Priority Data
Jun. 20, 2022 (JP) 2022-098636

(51) Int. Cl. F26B 5/14; B30B 9/20

(52) U.S. Cl. CPC F26B 5/14; F26B 2210/14; B30B 9/20

(57) ABSTRACT

In a veneer dewatering apparatus, a clutch 30 is arranged on a power transmission path between upper and lower rolls 4, 6 and rotating shafts 20. When a veneer portion without a part such as a knot having extremely high compressive strength compared to the other parts passes between the upper roll 4 and the lower roll 6, or when a veneer passes between the upper roll 4 and the lower roll 6 with no foreign matter such as dust interposed between the upper and lower rolls 4, 6 and the veneer, the clutch 30 connects the upper and lower rolls 4, 6 to the rotating shafts 20. When a veneer passes between the upper and lower rolls 4, 6 with a knot and other foreign matters intervening, the connection between the upper and lower rolls 4, 6 and the rotating shafts 20 by the clutch 30 is released.

### FIELD

The invention relates to a veneer dewatering apparatus and a dewatering veneer method for removing water from a veneer.

### BACKGROUND

Japanese Patent Application Publication No. 2013-240899 (Patent Document 1) describes a dewatering apparatus including a device frame, an upper roll rotatably supported by the frame, a lower roll arranged parallel to the upper roll and separated from the upper roll at a distance less than the thickness of a veneer, and a driving source for rotationally driving the upper and lower rolls in opposite directions from each other. In the dewatering apparatus, veneers pass between the upper and lower rolls to be compressed and dewatered.

In the dewatering apparatus, the upper roll includes an elastic cylindrical member. The elastic cylindrical member covers the outer peripheral surface of a metal shaft and has a plurality of grooves on the outer peripheral surface. The grooves have a depth inclining by a predetermined angle with respect to a straight line orthogonal to the axis of the elastic cylindrical member, in a cross section of the elastic cylindrical member cut along a virtual plane passing through the axis of the elastic cylindrical member. The configuration allows the elastic cylindrical member to elastically deform like collapsing in the inclination direction of the grooves when a veneer passes between the upper and lower rolls. As a result, the veneer is compressed in the direction of the elastic deformation of the elastic cylindrical member, that is, in the direction along the inclination direction of the grooves. As such, compared to the case where a veneer is compressed in the direction orthogonal to the axial direction of the upper and lower rolls (i.e., the direction orthogonal to the front and rear surfaces of a veneer), buckling and cracking are less likely to occur in the medullary rays of the veneer, and any reduction of the veneer in thickness is also less likely to occur.

### PRIOR ART DOCUMENTS

### Patent Documents

[Patent Document 1] Japanese Patent Application Publication No. 2013-240899

### SUMMARY

When a veneer passes between the upper and lower rolls, the elastic cylindrical member is compressed and deformed at the contact portion with the veneer. This causes a peripheral speed difference within the on the outer peripheral surface of the elastic cylindrical member in the circumferential direction of the elastic cylindrical member. On the other hand, the frictional force that is to be generated between the elastic cylindrical member and a veneer is set to a relatively high value in order to feed the veneer by the upper and lower rolls. Thus, the peripheral speed difference within the outer peripheral surface of the elastic cylindrical member in the circumferential direction of the elastic cylindrical member cannot be canceled by the sliding between the elastic cylindrical member and the veneer: instead, the difference is absorbed by the deformation of the elastic cylindrical member, specifically the deformation of the elastic cylindrical member caused by the force that the veneer pulls the elastic cylindrical member (hereinafter, simply referred to as “pulling force of a veneer”) generated in the direction the veneer passes (veneer conveying direction). Here, when a relatively hard part such as a knot of a veneer passes between the upper and lower rolls, or when a veneer with foreign matter attached thereto passes between the upper and lower rolls, the elastic cylindrical member is excessively compressed and deforms, resulting in an excessive difference in the peripheral speed within the outer peripheral surface of the elastic cylindrical member. Thus, the compression and deformation of the elastic cylindrical member due to the pulling force of the veneer may exceed the elastic region. As a result, the elastic cylindrical member may be damaged, and the durability of the elastic cylindrical member may be lowered due to fatigue.

The above-described veneer dewatering apparatus can decrease the reduction in thickness of a veneer, but does not include any disclosure about the lowered durability of the elastic cylinder. Therefore, there is still room for improvement in terms of the durability of the elastic cylindrical member.

The present invention has been made in view of the above, and an object of the present invention is to provide a technique that contributes to improving the durability of elastic cylinders of a first roll or a second roll in a veneer dewatering apparatus.

A veneer dewatering apparatus of the present invention has adopted the following means to achieve the above-mentioned object.

According to a preferred embodiment of a veneer dewatering apparatus of the present invention, a veneer dewatering apparatus is configured to extract water contained in a veneer. The veneer dewatering apparatus includes a frame, a first roll rotatably supported by the frame, a second roll rotatably supported by the frame, and a rotation driving unit configured to drive to rotate at least one of the first and second rolls. The second roll is disposed parallel to the first roll at a distance smaller than a thickness of the veneer from the first roll. Also, the first and second rolls, at least one of which is driven by the rotation driving unit, each include a shaft rotatably supported by the frame, a cylinder disposed coaxially with the shaft on the outer periphery of the shaft, an elastic cylindrical member arranged integrally on the outer periphery of the cylinder and coaxially with the shaft, and a connecting unit positioned in a power transmission path between the shaft and the cylinder. The connecting unit is configured to connect the shaft and the cylinder to rotate them integrally when the elastic cylindrical member contacts the veneer in a first state. The connecting unit is also configured to release the connection between the shaft and the cylinder to rotate them relative to each other when the elastic cylindrical member contacts the veneer in a second state. Here, the “second roll is disposed at a distance smaller than a thickness of the veneer from the first roll” typically corresponds to an aspect where the second roll is arranged such that the distance between the outer peripheral surface of the first roll and the outer peripheral surface of the second roll is, at the closest point to each other, smaller than the thickness of a veneer. The “first state” typically corresponds to a state where the elastic cylindrical member is in contact with a veneer portion without a part, such as a knot, of extremely high compressive strength compared to the other parts, and a state where no foreign matter such as dust is caught between the elastic cylindrical member and a veneer. In the first state, the deformation of the elastic cylindrical member due to the pulling force of the veneer remains relatively small because the compression and deformation of the elastic cylindrical member is relatively small and the difference in the peripheral speed within the outer peripheral surface of the elastic cylindrical member is relatively small. The “second state” typically corresponds to a state where the elastic cylindrical member is in contact with a part of a veneer, such as a knot, having extremely high compressive strength compared to the other parts and a state where foreign matter such as dust is caught between the elastic cylindrical member and a veneer. In the second state, the compression and deformation of the elastic cylindrical member is larger than in the first state and the difference in peripheral speed within the outer peripheral surface of the elastic cylindrical member is larger than in the first state, and thereby the deformation of the elastic cylindrical member due to the pulling force of the veneer is larger than in the first state.

According to the present invention, the shafts and the cylinders are integrally rotated in a state where the deformation of the elastic cylindrical member due to the pulling force of a veneer is relatively small, for example in a state where the elastic cylindrical member is in contact with the veneer portion without a part, such as a knot, of extremely high compressive strength compared to the other parts and in a state where no foreign matter such as dust is caught between the elastic cylindrical member and the veneer. As a result, the veneer can be well conveyed and compressed by the first and second rolls, which results in satisfactory dewatering of the veneers. In contrast, the shafts and the cylinders are rotated relative to each other in a state where the deformation of the elastic cylindrical member is relatively large, for example in a state where the elastic cylindrical member is in contact with a part of a veneer, such as a knot, having extremely high compressive strength compared to the other parts and in a state where some foreign matter such as dust is caught between the elastic cylindrical member and a veneer. Specifically, the shaft and the cylinder are rotated relative to each other when deformation of the elastic cylindrical member due to the pulling force of a veneer exceeds the elastic region. As a result, the deformation of the elastic cylindrical member due to the pulling force of a veneer can be decreased. Thus, the deformation of the elastic cylindrical member due to the pulling force of a veneer can be well managed from exceeding the elastic region. As a result, damage of the elastic cylindrical member and deterioration of the durability of the elastic cylindrical member can be decreased satisfactorily.

According to another embodiment of a veneer dewatering apparatus of the present invention, the connecting unit includes a circular plate supported by the shaft to be rotatable with the shaft, and a friction plate facing the circular plate, at least a part of the friction plate being arranged in the cylinder to be rotatable with the cylinder, and a pressing unit configured to press the friction plate against the circular plate.

According to the present embodiment, when the elastic cylindrical member contacts a veneer in the first state, the friction between the circular plate and the friction plate causes the shaft and the cylinder to rotate together, and when the elastic cylindrical member contacts a veneer in the second state, slippage is caused between the circular plate and the friction plate, which rotates the shaft and the cylinder relative to each other. As a result, the connection and disconnection between the shaft and the cylinder can be achieved by a simple structure.

According to another embodiment of a veneer dewatering apparatus of the present invention, the friction plate includes a first friction plate and a second friction plate, the first friction and second friction plates being, respectively, disposed axially on both sides of the shaft with respect to the circular plate. The pressing unit is configured to press at least one of the first and second friction plates directly against the circular plate.

According to the present embodiment, compared to a configuration in which one friction plate contacts the circular plate, the frictional force between the friction plates and the circular plate can be increased.

According to another embodiment of a veneer dewatering apparatus of the present invention, the cylinder includes at least a first cylinder and a second cylinder, the first and second cylinders being arranged in series axially of the shaft and restrained from moving axially of the shaft. The elastic cylindrical member includes a first elastic cylindrical member and a second elastic cylindrical member, the first and second elastic cylindrical members being, respectively, arranged integrally with outer peripheries of the first and second cylinders.

The first friction plate is disposed in the first cylinder, and the second friction plate is disposed in the second cylinder.

According to the present embodiment, a plurality of cylinders each including an elastic cylindrical member are arranged in series axially of the shaft. Thus, an operation is possible in which only the cylinder having an elastic cylindrical member that is in contact with apart including a knot or the like of a veneer (only one of the first cylinder and the second cylinder) or only the cylinder having the elastic cylindrical member that has captured in foreign matter (only one of the first cylinder and the second cylinder) rotates relative to the shaft, while the cylinder having the other elastic cylindrical member (the other one of the first cylinder and the second cylinder) rotates with the shaft. As a result, a veneer can be dewatered while less deterioration in durability of the elastic cylinders occurs.

In addition, since only one circular plate is necessary for two cylinders (the first and the second cylinders), the number of components required can be reduced compared to a configuration using two circular plates for two cylinders (the first and the second cylinders).

According to another embodiment of a veneer dewatering apparatus of the present invention, the cylinder includes at least a first cylinder and a second cylinder, the first and second cylinders being arranged in series axially of the shaft and restrained from moving axially of the shaft. The elastic cylindrical member includes a first elastic cylindrical member and a second elastic cylindrical member, the first and second elastic cylindrical members being, respectively, arranged integrally with outer peripheries of the first and second cylinders. The circular plate includes a first circular plate and a second circular plate. The friction plate includes a third friction plate and a fourth friction plate, respectively, disposed axially on both sides of the shaft with respect to the first circular plate, and includes a fifth friction plate and a sixth friction plate, respectively, disposed axially on both sides of the shaft with respect to the second circular plate. The third and fourth friction plates are disposed in the first cylinder, and the fifth and sixth friction plates are disposed in the second cylinder. The pressing unit is configured to press at least one of the third and fourth friction plates directly against the first circular plate, and is configured to press at least one of the fifth and sixth friction plates directly against the second circular plate.

According to the present embodiment, a plurality of cylinders each including an elastic cylindrical member are arranged in series axially of the shaft. Thus, an operation is possible in which only the cylinder having an elastic cylindrical member that is in contact with the part including a knot or the like of a veneer (only one of the first cylinder and the second cylinder) or only the cylinder having the elastic cylindrical member that has captured in foreign matter (only one of the first cylinder and the second cylinder) rotates relative to the shaft, while the cylinder having the other elastic cylindrical member (the other one of the first cylinder and the second cylinder) rotates with the shaft. As a result, a veneer can be dewatered while less deterioration in durability of the elastic cylinders occurs. In addition, since one circular plate is arranged for each of the two cylinders (the first and the second cylinders) and two friction plates are brought in contact with each of the circular plates, the frictional force between the friction plates and the circular plates can be increased compared to a configuration in which one circular plate contacts with one friction plate.

According to another embodiment of a veneer dewatering apparatus of the present invention, the connecting unit includes at least one friction member having an arc-shaped friction material, a cylindrical hub interposed between the friction member and the shaft, and an urging unit disposed at least partially on the cylindrical hub. The friction member is interposed between the shaft and the cylinder such that the friction material faces an inner peripheral surface of the cylinder.

The cylindrical hub is supported by the shaft to integrally rotate with the shaft and is connected to the friction member to integrally rotate with the friction member. The urging unit is configured to urge the friction member radially outward so that the friction material contacts the inner peripheral surface of the cylinder.

According to the present embodiment, when the elastic cylindrical member contacts a veneer in the first state, the frictional force between the friction material of the friction member and the inner peripheral surface of the cylinder causes the shaft and the cylinder to rotate together, and when the elastic cylindrical member contacts a veneer in the second state, the slippage between the friction material of the friction member and the inner peripheral surface of the cylinder causes the shaft and the cylinder to rotate relative to each other. As a result, the connection and disconnection between the shaft and the cylinder can be achieved by a simple structure.

According to another embodiment of a veneer dewatering apparatus of the present invention, the urging unit is an elastic body disposed on the outer periphery of the cylindrical hub.

According to the present embodiment, the urging unit can be achieved by a simple structure.

According to another embodiment of a veneer dewatering apparatus of the present invention, the urging unit includes a fluid passage, at least one first radial through-hole, at least one second radial through-hole, and a fluid supply source. The fluid passage is positioned through the shaft to extend axially of the shaft. The first radial through-hole is open to face an inner peripheral surface of the friction member and extends through the shaft to the fluid passage. The second radial through-hole radially extends through the cylindrical hub and is in communication with the first radial through-hole. The fluid supply source is connected to the fluid passage so as to supply a fluid to the fluid passage.

According to the present embodiment, when the elastic cylindrical member contacts a veneer in the first state, a fluid pressure is applied to the inner peripheral surface of the friction member so as to cause the shaft and the cylinder to rotate together, and when the elastic cylindrical member contacts a veneer in the second state, no fluid pressure is applied to the inner peripheral surface of the friction member so as to cause the shaft and the cylinder to rotate relative to each other. As such, the shaft and the cylinder are completely disconnected from each other in the second state, and the circumferential speed difference in the circumferential direction of the elastic cylindrical member can be well absorbed. Thus, the deformation of the elastic cylindrical member due to the pulling force of a veneer can be further satisfactorily managed from exceeding the elastic region. As a result, deterioration in durability of the elastic cylindrical member is further less likely to occur.

According to another embodiment of a veneer dewatering apparatus of the present invention, the cylinder includes at least a first cylinder and a second cylinder, the first and second cylinders being arranged in series axially of the shaft and restrained from moving axially of the shaft. The elastic cylindrical member includes a first elastic cylindrical member and a second elastic cylindrical member, the first and second elastic cylindrical members being, respectively, arranged integrally with the outer peripheries of the first and second cylinders. The friction member includes a first friction member interposed between the shaft and the first cylinder and a second friction member interposed between the shaft and the second cylinder. The cylindrical hub includes a first cylindrical hub interposed between the shaft and the first friction member and a second cylindrical hub interposed between the shaft and the second friction member. The urging unit includes a first urging unit and a second urging unit. The first urging unit is disposed at least partially on the first cylindrical hub so as to urge the first friction member radially outward, and the second urging unit is disposed at least partially on the second cylindrical hub so as to urge the second friction member radially outward.

According to the present embodiment, a plurality of cylinders each including an elastic cylindrical member are arranged in series axially of the shaft. Thus, an operation is possible in which only the cylinder having an elastic cylindrical member that is in contact with a part including a knot or the like of a veneer (only one of the first cylinder and the second cylinder) or only the cylinder having the elastic cylindrical member that has captured in foreign matter (only one of the first cylinder and the second cylinder) rotates relative to the shaft, while the cylinder having the other elastic cylindrical member (the other one of the first cylinder and the second cylinder) rotates with the shaft. As a result, a veneer can be dewatered while less deterioration in durability of the elastic cylinders occurs.

According to another embodiment of a veneer dewatering apparatus of the present invention, the cylinder has a circular arc groove on its surface facing axially of the shaft.

The connecting unit includes a circular plate supported by the shaft to be rotatable with the shaft, and an urging unit disposed in the circular arc groove.
The circular plate has a projection extending axially of the shaft so as to be engageable with the circular arc groove.
The urging unit is configured to urge the circular plate in the rotational direction of the shaft via the projection.

According to the present embodiment, when the elastic cylindrical member contacts a veneer in the first state, the urging unit urges the circular plate in the rotational direction of the shaft via the projection, so that the shaft rotates together with the cylinder, and when the elastic cylindrical member contacts a veneer in the second state, the circular plate and the cylinder, that is, the shaft and the cylinder, relatively rotate within the range of the circumferential length of the circular arc groove. As a result, the connection and disconnection between the shaft and the cylinder can be achieved by a simple structure.

According to another embodiment of a veneer dewatering apparatus of the present invention, the cylinder includes at least a first cylinder and a second cylinder, the first and second cylinders being arranged in series axially of the shaft and restrained from moving axially of the shaft. The elastic cylindrical member includes a first elastic cylindrical member and a second elastic cylindrical member, the first and second elastic cylindrical members being, respectively, arranged integrally with the outer peripheries of the first and second cylinders. The circular arc groove includes a first circular arc groove on the first cylinder and a second circular arc groove disposed on the second cylinder to face the first circular arc groove. The projection includes a first projection extending axially of the shaft so as to be engageable with the first circular arc groove, and a second projection extending axially of the shaft in the direction away from the first projection so as to be engageable with the second circular arc groove. The urging unit includes a first urging unit and a second urging unit. The first urging unit is disposed in the first circular arc groove and configured to urge the circular plate via the first projection in the rotation direction of the shaft, and the second urging unit is disposed in the second circular arc groove and configured to urge the circular plate via the second projection in the rotation direction of the shaft.

According to the present embodiment, a plurality of cylinders each including an elastic cylindrical member are arranged in series axially of the shaft. Thus, an operation is possible in which only the cylinder having an elastic cylindrical member that is in contact with the part including a knot or the like of a veneer (only one of the first cylinder and the second cylinder) or only the cylinder having the elastic cylindrical member that has captured in foreign matter (only one of the first cylinder and the second cylinder) rotates relative to the shaft, while the cylinder having the other elastic cylindrical member (the other one of the first cylinder and the second cylinder) rotates integrally with the shaft. As a result, veneers can be dewatered while less deterioration in durability of the elastic cylinders occurs. In addition, since only one circular plate is necessary for two cylinders (the first and the second cylinders), the number of components required can be reduced compared to a configuration using two circular plates for two cylinders (the first and the second cylinders). As a result, the device can be downsized.

According to another embodiment of a veneer dewatering apparatus of the present invention, the first and second rolls each have at least first and second cylinders and first and second elastic cylindrical members that are arranged integrally on the outer peripheries of the first and second cylinders, respectively. The first and second elastic cylindrical members of each of the first and second rolls have a substantially Z-shape cross section, on one side with respect to the axis of the first and second elastic cylindrical members, when cut along a virtual plane passing through the axis of the first and second elastic cylindrical members. The first and second rolls are arranged such that first cast shadows of the first and second elastic cylindrical members of the first roll on the virtual plane is in point symmetry, with respect to a predetermined point on the virtual plane, with second cast shadows of the first and second elastic cylindrical members of the second roll on the virtual plane.

According to the present embodiment, when a veneer passes between the first and second rolls, the first and second elastic cylindrical members of each of the first and second rolls deform (bend) in a direction inclined relative to the direction orthogonal to the axis of the shaft. Thus, the veneer can be compressed in the direction identical to the direction the first and second elastic cylindrical members deform. As a result, it is possible to decrease buckling and cracking that leads to plastic deformation of the medullary rays of a veneer, compared to a configuration in which a veneer is compressed in the direction orthogonal to the front and rear surfaces of the veneer. Note that the first and second elastic cylindrical members of the first roll deform (bend) axially of the shaft in a direction opposite to that the first and second elastic cylindrical members of the second roll deform (bend). Thus, the medullary rays in a veneer can be deformed into a substantially rhombic tubular shape. Therefore, it is possible to further decrease buckling and cracking that leads to plastic deformation of the medullary rays of a veneer.

Conventionally, multiple grooves disposed in an elastic cylindrical member and inclined with respect to the direction perpendicular to the axial direction of a shaft were used to deform a veneer in the same direction as the deformation direction of the elastic cylindrical member. However, if the multiple grooves have a large groove width, when a veneer passes between the first and second rolls, the veneer could bite into the grooves, sometimes causing so-called plucking. However, according to the present embodiment, the first and second elastic cylindrical members of each of the first and second rolls have, on one side, a substantially Z-shape cross section. As such, the axial gap between the first and second elastic cylindrical members can be reduced compared to the conventional configuration in which an elastic cylindrical member have multiple grooves. As a result, without sacrificing the ease of deformation (flexibility) of the first and second elastic cylindrical members, the risk that a veneer bites into the gap in the axial direction between the first and second elastic cylindrical members and so-called plucking is caused can be effectively prevented.

According to a preferred embodiment of a method of dewatering veneer of the present invention, a dewatering veneer method is provided for removing water from a veneer. In the dewatering veneer method, a veneer is dewatered using a veneer dewatering apparatus including a frame, a first roll rotatably supported by the frame, a second roll rotatably supported by the frame, and a rotation driving unit configured to drive to rotate at least one of the first and second rolls. Here, the second roll is arranged parallel to the first roll at a distance smaller than a thickness of the veneer from the first roll. The first and second rolls, at least one of which is driven by the rotation driving unit, each include a shaft rotatably supported by the frame, a cylinder disposed coaxially with the shaft on the outer periphery of the shaft, and an elastic cylindrical member integrally arranged on the outer periphery of the cylinder and coaxially with the shaft. The dewatering veneer method includes: connecting the shaft to the cylinder to cause the shaft and the cylinder to rotate integrally when the elastic cylindrical member contacts a veneer in a first state; and releasing the connection between the shaft and the cylinder to cause the shaft and the cylinder to rotate relative to each other when the elastic cylindrical member contacts the veneer in a second state, so that the water contained in the veneer is dewatered. Here, the “second roll is disposed at a distance smaller than a thickness of the veneer from the first roll” typically corresponds to an aspect where the second roll is arranged such that the distance between the outer peripheral surface of the first roll and the outer peripheral surface of the second roll is, at the closest point to each other, smaller than the thickness of a veneer. The “first state” typically corresponds to a state where the elastic cylindrical member is in contact with a veneer portion without a part, such as a knot, of extremely high compressive strength compared to the other parts, and a state where no foreign matter such as dust is caught between the elastic cylindrical member and a veneer. In the first state, the deformation of the elastic cylindrical member due to the pulling force of the veneer remains relatively small because the compression and deformation of the elastic cylindrical member is relatively small, and thereby the peripheral speed difference within the outer peripheral surface of the elastic cylindrical member is relatively small. The “second state” typically corresponds to a state where the elastic cylindrical member is in contact with a part of a veneer, such as a knot, having extremely high compressive strength compared to the other parts and a state where some foreign matter such as dust is caught between the elastic cylindrical member and a veneer. In the second state, the compression and deformation of the elastic cylindrical member is larger than in the first state and the peripheral speed difference within the outer peripheral surface of the elastic cylindrical member is larger than in the first state, and thereby the deformation of the elastic cylindrical member due to the pulling force of the veneer increases.

According to the present invention, the shaft and the cylinder are integrally rotated in a state where the deformation of the elastic cylindrical member due to the pulling force of a veneer is relatively small, for example in a state where the elastic cylindrical member is in contact with a veneer portion without a part, such as a knot, of extremely high compressive strength compared to the other parts and in a state where no foreign matter such as dust is caught between the elastic cylindrical member and a veneer. As a result, a veneer can be well transferred and compressed by the first and second rolls, which results in satisfactory dewatering of the veneer. In contrast, the shaft and the cylinder are rotated relative to each other in a state where the deformation of the elastic cylindrical member due to the pulling force of a veneer is relatively large, for example in a state where the elastic cylindrical member is in contact with a part of a veneer, such as a knot, having extremely high compressive strength compared to the other parts and a state where some foreign matter such as dust is caught between the elastic cylindrical member and a veneer. Specifically, the shaft and the cylinder are rotated relative to each other when deformation of the elastic cylindrical member due to the pulling force of a veneer exceeds the elastic region. As a result, the deformation of the elastic cylindrical member due to the pulling force of a veneer can be decreased. Thus, the deformation of the elastic cylindrical member due to the pulling force of a veneer can be well managed from exceeding the elastic region. As a result, breakage of the elastic cylindrical member and deterioration of the durability of the elastic cylindrical member can be decreased satisfactorily.

According to the present invention, the durability of the elastic cylindrical member of each of first and second rolls in a veneer dewatering apparatus can be improved.

### BRIEF DESCRIPTION OF THE DRAWINGS

FIG. 1 is a perspective view showing a schematic configuration of a veneer dewatering apparatus 1 according to one embodiment.

FIG. 2 is a diagram viewed along the direction of arrow V in FIG. 1.

FIG. 3 is a perspective view showing part of an upper roll 4 (a lower roll 6).

FIG. 4 is a cross-sectional diagram showing a cross section of the upper roll 4 (the lower roll 6) taken along a virtual plane passing the axis of a rotating shaft 20.

FIG. 5 is a cross-sectional diagram showing a cross section of the rotating shaft 20 cut along a virtual plane perpendicular to the axis of the rotating shaft 20.

FIG. 6 is a plan view of a narrow roll 22 (a narrow roll 24).

FIG. 7 is a cross-sectional diagram showing a cross section along X-X in FIG. 6.

FIG. 8 is an enlarged diagram of a main part designated by the arrow W in FIG. 7.

FIG. 9 is an explanatory diagram showing the positional relationship between the upper roll 4 and the lower roll 6.

FIG. 10 is a perspective view showing a configuration of a clutch 30.

FIG. 11 is a plan view of a disk 32.

FIG. 12 is a plan view of a friction plate 34.

FIG. 13 is an explanatory diagram showing the positional relationship between the narrow rolls 22, 24 and the clutch 30.

FIG. 14 is an explanatory diagram showing deformation of an elastic cylindrical member 46.

FIG. 15 is an explanatory diagram showing the states of a cut end surface of a veneer (deformation of medullary rays) before and during dewatering.

FIG. 16 is an explanatory diagram showing a configuration of a modified veneer dewatering apparatus 100.

FIG. 17 is a plan view of a narrow roll 122.

FIG. 18 is a cross-sectional diagram showing a cross section along Y-Y in FIG. 17.

FIG. 19 is a perspective view showing the appearance of the narrow roll 122.

FIG. 20 is an explanatory diagram showing a configuration of a modified veneer dewatering apparatus 200.

FIG. 21 is an explanatory diagram showing an arrangement of a clutch 230 in a narrow roll 222.

FIG. 22 is a plan view of the narrow roll 222.

FIG. 23 is a cross-sectional view showing a cross section along Z-Z in FIG. 21.

FIG. 24 is a plan view of a clutch 230.

FIG. 25 is an explanatory diagram showing the assemble of the clutch 230 to the narrow roll 222.

FIG. 26 is an explanatory diagram showing a configuration of a modified veneer dewatering apparatus 300.

FIG. 27 is an explanatory diagram showing an arrangement of a clutch 330 in the narrow roll 322.

FIG. 28 is a plan view showing a narrow roll 322 having the clutch 330 arranged therein.

FIG. 29 is an explanatory diagram showing the connection relationship between an in-shaft flow path 320b, the radial flow paths 320c, and stepped holes 333.

FIG. 30 is an explanatory diagram showing the assemble of a brake shoe 334 to a hub 332.

FIG. 31 is an explanatory diagram showing a configuration of a modified veneer dewatering apparatus 400.

FIG. 32 is a plan view of a narrow roll 422.

FIG. 33 is a cross-sectional diagram showing a cross section along S-S in FIG. 32.

FIG. 34 is a plan view of a narrow roll 424.

FIG. 35 is a cross-sectional view showing a cross section along T-T in FIG. 34.

FIG. 36 is a plan view of a clutch 430.

FIG. 37 is a side view of the clutch 430.

FIG. 38 is an explanatory diagram showing the positional relationship between the narrow rolls 422, 424 and the clutch 430.

FIG. 39 is an explanatory diagram showing the relative rotation between the narrow rolls 422, 424 and the rotating shafts 20, 20.

### DETAILED DESCRIPTION

Next, the best embodiment for carrying out the present invention is described with reference to an example.

### Example 1

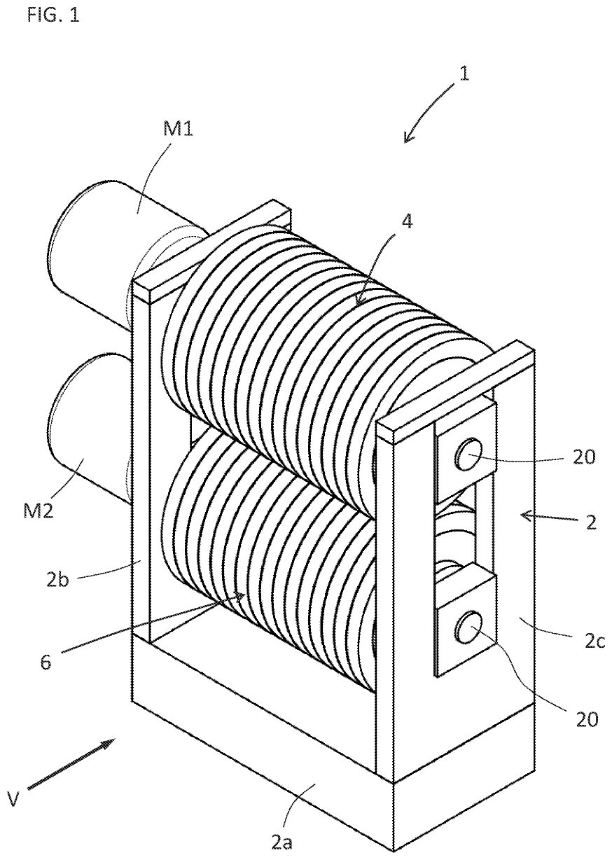

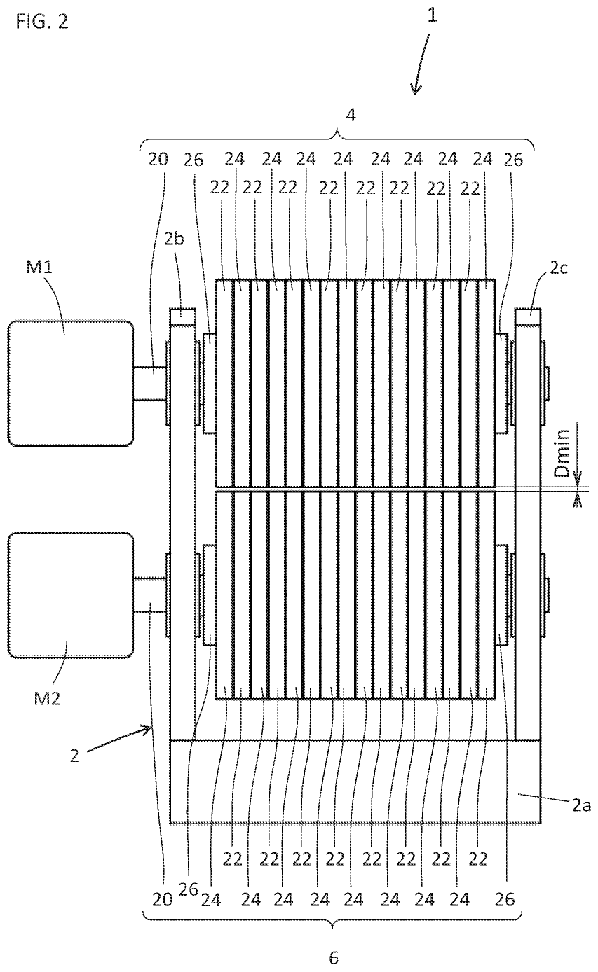

As shown in FIGS. 1 and 2, a veneer dewatering apparatus 1 according to one embodiment of the present invention includes a frame 2, an upper roll 4 and a lower roll 6 both rotatably supported by the frame, a motor M1 for rotationally driving the upper roll, and a motor M2 for rotationally driving the lower roll. The veneer dewatering apparatus 1 mechanically removes the water contained in a veneer by passing the veneer between the upper roll 4 and the lower roll 6. The motors M1 and M2 are an example of an implemented configuration corresponding to the “rotation driving unit” in the present invention.

As shown in FIG. 2, the frame 2 includes a base 2a, a pair of support walls 2b, 2c on the base 2a. The frame 2 has a substantially U shape when viewed from the front. The support walls 2b, 2c rotatably support later-described rotating shafts 20, 20 of the upper roll 4 and the lower roll 6, respectively, via bearings (not shown).

As shown in FIGS. 1 and 2, the upper roll 4 and the lower roll 6 are supported by the pair of support walls 2b, 2c so that the shaft lines (that is, the rotating shafts 20, 20 to be described later) are parallel to each other. As shown in FIG. 2, the upper roll 4 and the lower roll 6 are arranged so that the distance Dmin between their outer peripheral surfaces is, at the closest point to each other, smaller than the thickness t of a veneer (Dmin<t).

The upper roll 4 and the lower roll 6 are basically the same in configuration, and the upper roll 4 will be mainly described below.

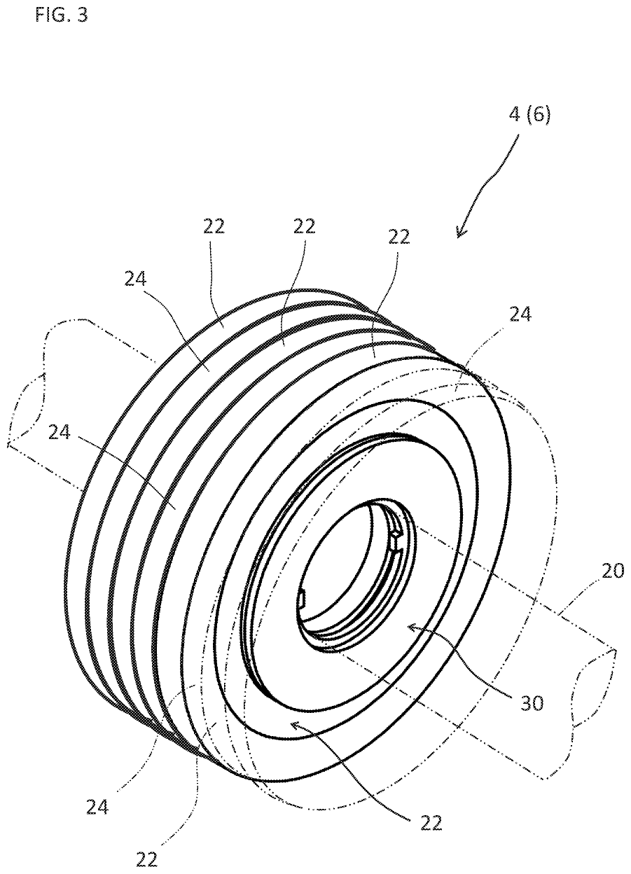

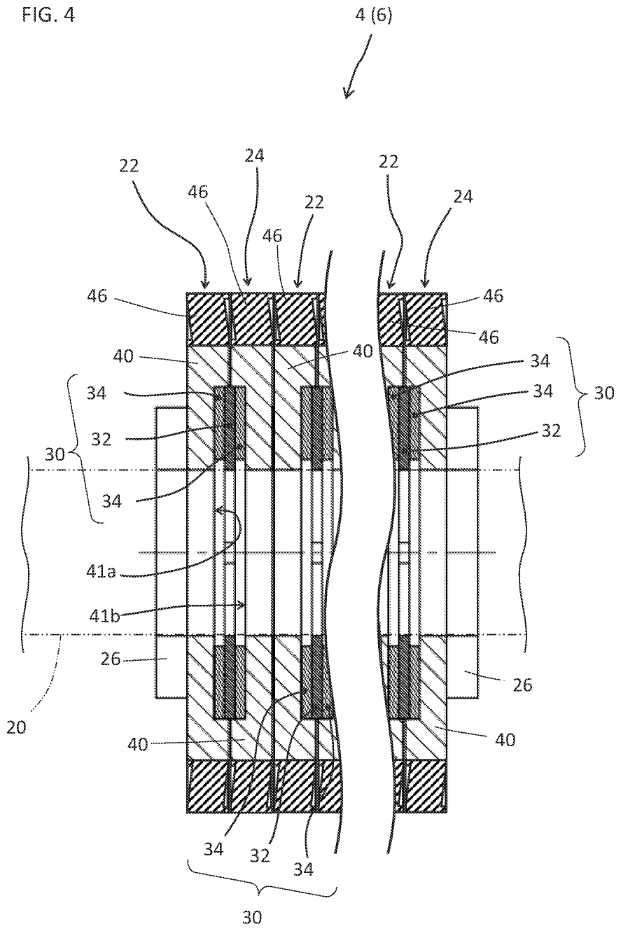

As shown in FIGS. 2 to 4, the upper roll 4 includes a rotating shaft 20, a plurality of narrow rolls 22, 24, . . . , 22, 24 that are supported by the rotating shaft 20, a plurality of clutches 30, 30, . . . , 30 (see FIG. 4), and a pair of stoppers 26, 26 disposed on either end of the rotating shaft 20 in the axial direction. The upper roll 4 and the lower roll 6 correspond, respectively, to the “first roll” and the “second roll” in the present invention, and the clutches 30 are an example of an implemented configuration corresponding to the “connecting unit” in the present invention. The stoppers 26 are an example of an implemented configuration corresponding to the “connecting unit” and the “pressing unit” in the present invention.

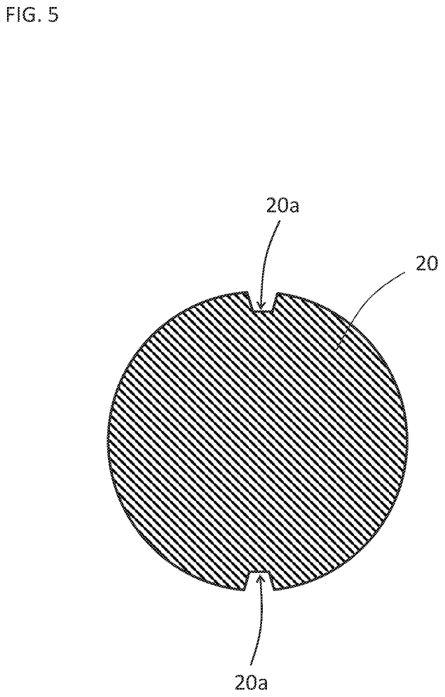

As shown in FIG. 2, the rotating shaft 20 is, at one end in the axial direction, connected to a rotating shaft (not shown) of the motor M1 (the motor M2 in the case of the rotating shaft 20 of the lower roll 6). As shown in FIG. 5, the rotating shaft 20 has two grooves 20a, 20a on its outer peripheral surface. The grooves 20a, 20a are arranged evenly in the circumferential direction of the rotating shaft 20. Also, the grooves 20a, 20a extend axially of the rotating shaft 20. The motors M1 and M2 are driven and controlled so that the rotating shaft 20 of the upper roll 4 and the rotating shaft 20 of the lower roll 6 rotates in the opposite directions to each other. The rotating shaft 20 is an example of an implemented configuration corresponding to the “shaft” in the present invention.

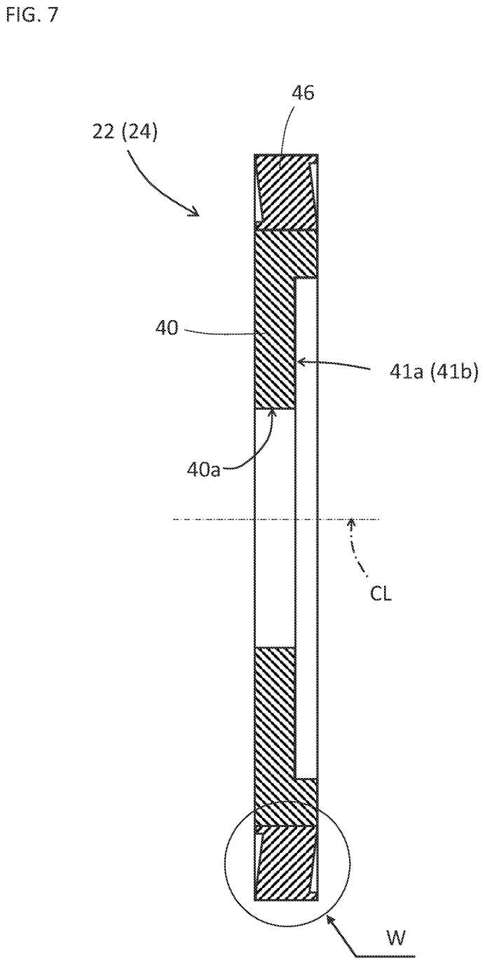

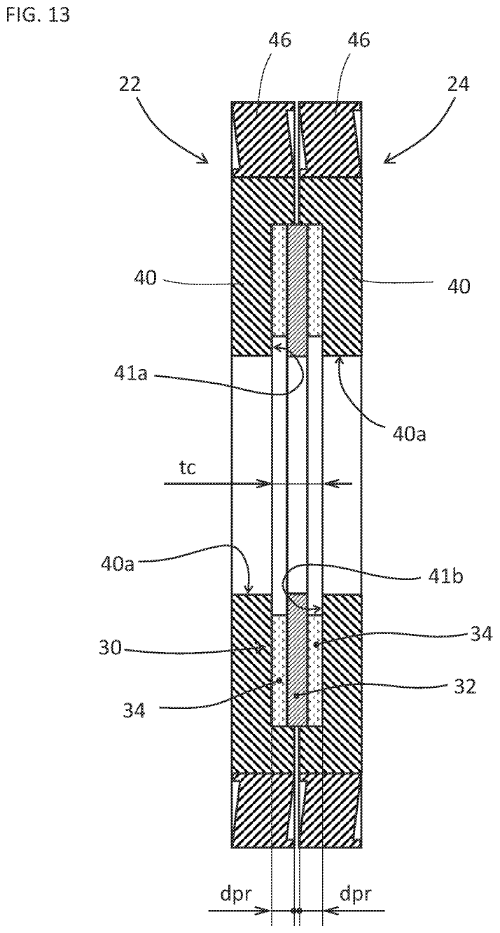

As shown in FIGS. 2 to 4, the narrow rolls 22, 24 are arranged in series axially of the rotating shaft 20 (in the left-right direction in FIGS. 2 to 4). As shown in FIG. 4, the narrow rolls 22, 24 are basically the same in configuration except that recesses 41a, 41b (see also FIG. 7), which will be described later, are different in the direction to be open. Accordingly, the narrow roll 22 will be mainly described below. Note that the recess 41a is open rightward, whereas the recess 41b is open leftward in FIG. 4. As shown in FIGS. 4 and 13, the narrow rolls 22, 24 are disposed such that the recesses 41a, 41b face each other via the clutches 30.

As shown in FIGS. 4, 6, and 7, the narrow rolls 22 each include a metal cylinder 40 disposed coaxially with the axis of the rotating shaft 20 on the outer peripheral surface of the rotating shaft 20, and an elastic cylindrical member 46 integrally disposed on the outer peripheral surface of the cylinder 40 to be coaxially with the axis of the rotating shaft 20.

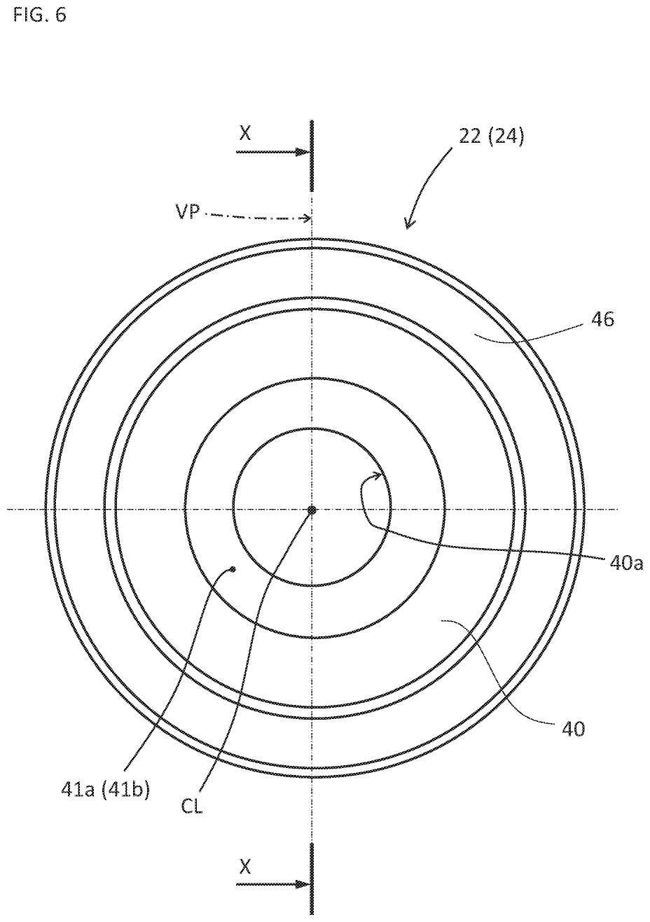

As shown in FIGS. 6 and 7, the cylinder 40 has a shaft insertion hole 40a and a recess 41a (a recess 41b in the narrow roll 24). The shaft insertion hole 40a has an inner diameter equal to or slightly larger than the outer diameter of the rotating shaft 20. The recess 41a (the recess 41b) is concentric with the shaft insertion hole 40a when viewed from the front (FIG. 6). The recess 41a (the recess 41b) also has a depth slightly larger than the thickness of the friction plates 34, 34 of the clutches 30 which will be described later. The recess 41a is axially open in one direction (rightward in FIGS. 4, 7 and 10) (in the left and right direction in FIGS. 4, 7 and 10). The recess 41b is axially open in the direction opposite to that of the recess 41a, that is, in the other direction (leftward in FIGS. 4, 7 and 10) (in the left and right direction in FIGS. 4, 7 and 10). Here, the cylinders 40 of the narrow rolls 22 and the cylinders 40 of the narrow rolls 24 are, respectively, an example of an implemented configuration corresponding to the “first cylinder” and the “second cylinder” in the present invention.

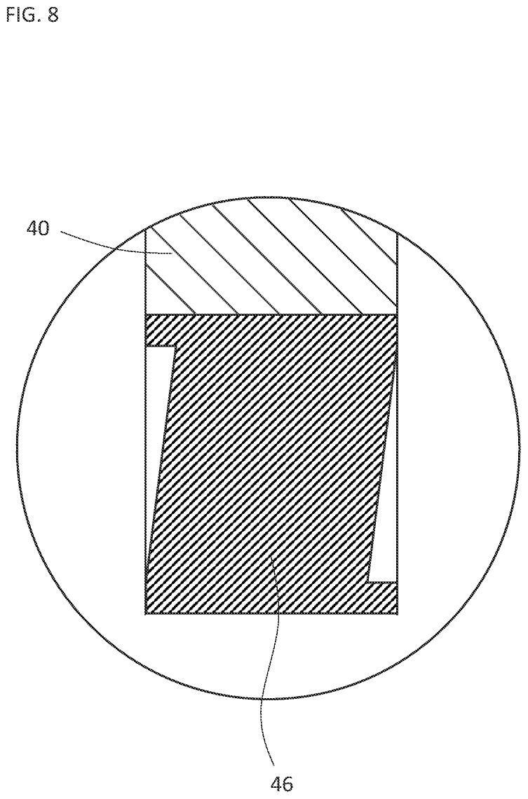

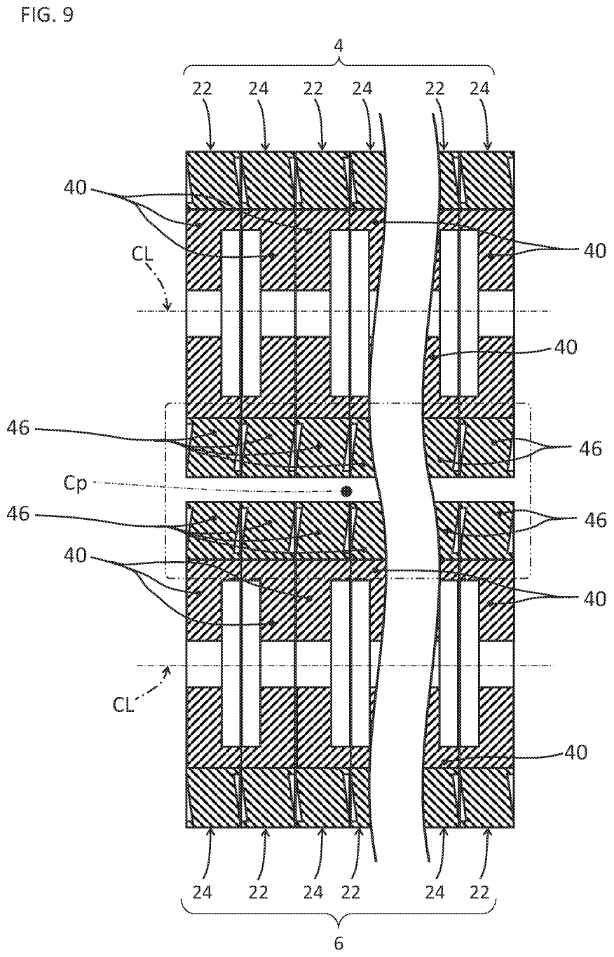

The elastic cylindrical member 46 is comprised of an elastic material such as urethane. As shown in FIGS. 7 and 8, the elastic cylindrical member 46 has a substantially Z-shape cross section, on one side (lower side in FIG. 7) with respect to the axis CL (see FIG. 6) of the elastic cylindrical member 46, that is a cross section (see FIG. 7) when cut along a virtual plane VP (see FIG. 6) passing through the axis CL of the elastic cylindrical member 46. Here, as shown in FIG. 9, in the upper roll 4, the elastic cylindrical member 46 is integrated with the cylinder 40 such that the cross-section on the lower side with respect to the axis CL is substantially Z-shaped. In contrast, in the lower roll 6, the elastic cylindrical member 46 is integrated with the cylinder 40 such that the cross section on the upper side with respect to the axis CL has a substantially Z shape. In other words, it can be said that the upper roll 4 and the lower roll 6 are arranged to have a point symmetry relationship between the cast shadow of the upper roll 4 on the virtual plane VP and the cast shadow of the lower roll 6 on the virtual plane VP with respect to a predetermined point CP on the virtual plane VP. Note that, as shown in FIG. 9, the predetermined point CP is positioned on the virtual plane VP between the cast shadow of the upper roll 4 and the cast shadow of the lower roll 6, and is also at an equal distance from the cast shadow of the upper roll 4 and the cast shadow of the lower roll 6: the predetermined point CP is defined as a centrally positioned point in the extending direction of the axis CL. Here, the elastic cylindrical member 46 integrated with the cylinder 40 of the narrow roll 22 and the elastic cylindrical member 46 integrated with the cylinder 40 of the narrow roll 24 are, respectively, an example of an implemented configuration corresponding to the “first elastic cylindrical member” and the “second elastic cylindrical member” in the present invention.

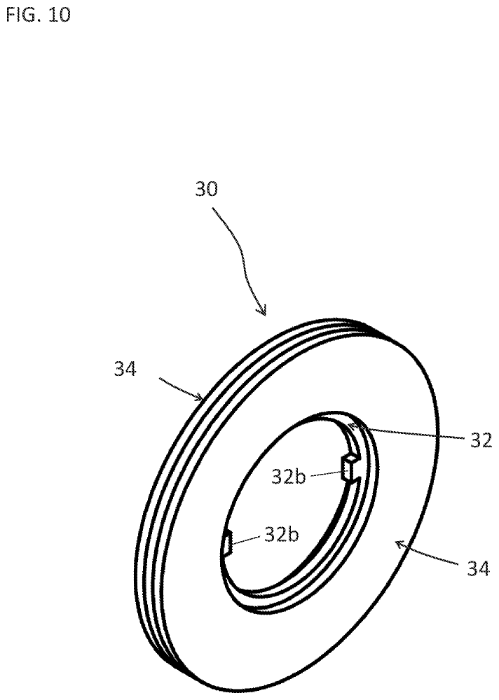

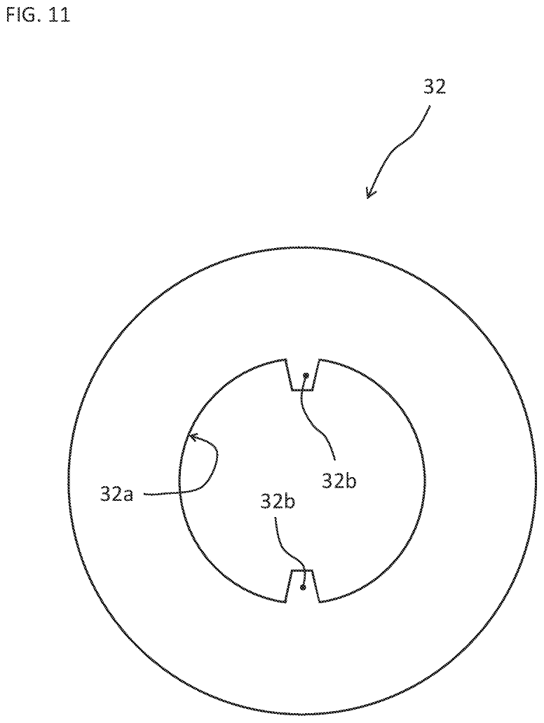

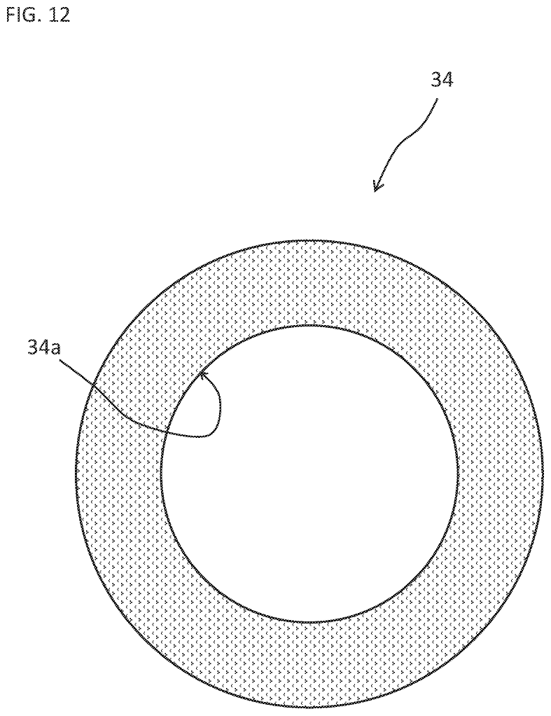

As shown in FIG. 10, the clutches 30 each have one disk 32 and two friction plates 34, 34 disposed so as to sandwich the disk 32 therebetween. As shown in FIG. 11, the disk 32 is a circular metal plate having a shaft insertion hole 32a in the center. The shaft insertion hole 32a has a diameter equal to or slightly larger than the outer diameter of the rotating shaft 20. The disk 32 also has a pair of projecting pieces 32b, 32b. As shown in FIG. 12, the projecting pieces 32b, 32b protrude from the inner peripheral surface (the shaft insertion hole 32a) of the disk 32 toward the center of the shaft insertion hole 32a. The projecting pieces 32b, 32b are arranged evenly in the circumferential direction of the shaft insertion hole 32a. As shown in FIG. 12, the friction plates 34 are each a circular plate that has an outer diameter equal to or slightly smaller than the inner diameter of the recess 41a and has a central hole 34a. The hole 34a has a diameter larger than that of the shaft insertion hole 32a. As shown in FIG. 13, the friction plates 34, 34 are disposed on the either side of the disk 32 in the axial direction. In the present embodiment, the friction plates 34, 34 have been attached to the disk 32 in advance. The integration of the disk 32 and the friction plates 34, 34 in this way can increase the ease of assembly. The disk 32 is an example of an implemented configuration corresponding to the “circular plate,” the “first circular plate,” and the “second circular plate” in the present invention. The friction plates 34 are an example of an implemented configuration corresponding to the “first friction plate” and the “second friction plate” in the present invention

As shown in FIG. 13, each clutch 30 of the above configuration is interposed between the recess 41a in the cylinder 40 of the narrow roll 22 and the recess 41b in the cylinder 40 of the narrow roll 24. That is, one of the two friction plates 34, 34 is disposed on the recess 41a side, and the other is disposed on the recess 41b via the disk 32. Here, the friction plates 34, 34 frictionally contact the recesses 41a, 41b, so as to rotate together with the narrow rolls 22, 24. In other words, the narrow rolls 22, 24 are rotatable integrally with the rotating shaft 20 via the clutch 30. As described above, in the present embodiment, only one clutch 30 is necessary for the one set of narrow rolls 22, 24. Thus, the number of parts required can be reduced compared to a configuration using the clutch 30 for each of the narrow rolls 22 and 24. Note that the thickness dimension tc of each clutch 30 (the dimension obtained by adding the thickness of the disk 32 and the thickness of the two friction plates 34, 34) is set to be slightly larger than twice the depth dpr of each of the recesses 41a, 41b (tc>2·dpr).

Next, an assembly of the veneer dewatering apparatus 1 of the above configuration will be described below. First, the upper roll 4 and the lower roll 6 are assembled: in assembling the upper roll 4 and the lower roll 6, first, plural sets of the narrow rolls 22, 24, . . . , 22, 24 are placed around the rotating shafts 20, 20 (see FIG. 2), wherein the narrow rolls 22, 24 having the clutches 30 between the recesses 41a, 41b are defined as one set (see FIG. 13). At this time, the projecting pieces 32b, 32b of the disks 32, 32 are engaged with the grooves 20a, 20a of the rotating shafts 20, 20, respectively. The configuration enables the disks 32, 32 to rotate integrally with the rotating shafts 20, 20. Subsequently, the stoppers 26, 26 are fixed to the rotating shafts 20, 20 individually by sandwiching the narrow rolls 22, 24, . . . , 22, 24 from both sides in the axial direction of the rotating shafts 20, 20 such that a predetermined axial pressing force acts on each clutch 30 (see FIG. 2). Here, the assembly of the upper roll 4 and the lower roll 6 is completed.

Next, the upper roll 4 and the lower roll 6 thus assembled are mounted on the frame 2 to be rotatably supported via the rotating shafts 20, 20, respectively, and the motors M1, M2 are connected to the respective rotating shafts 20, 20, which completes the assembly of the veneer dewatering apparatus 1.

Note that the surface roughness of the contact surfaces and the relationship between the thickness dimension tc and the depth dpr of the cylinders 40, 40 and the friction plates 34, 34, and the values of the above-mentioned axial pressing force by the stoppers 26, 26 are appropriately set (adjusted) such that: the frictional force generated between the cylinders 40, 40 and the friction plates 34, 34 is greater than the pulling force of a veneer (the friction force between a veneer and the upper and lower rolls 4, 6, that is, the elastic cylindrical members 46) when each elastic cylindrical member 46 of the upper and lower rolls 4, 6 is in contact with a veneer portion without a part, such as a knot, of extremely high compressive strength compared to the other parts, and when each elastic cylindrical member 46 of the upper and lower rolls 4, 6 is in contact with a veneer in a state where no foreign matter such as dust is caught between the elastic cylindrical members 46 of the upper and lower rolls 4, 6 and a veneer (hereinafter, referred to as “first state”); and the friction force generated between the cylinders 40, 40 and the friction plates 34, 34 is smaller than the pulling force of a veneer (the friction force between the veneer and the upper and lower rolls 4, 6, that is, the elastic cylindrical members 46) when the upper and lower rolls 4, 6 (the elastic cylindrical members 46) are in contact with a veneer portion with a part, such as a knot, of extremely high compressive strength compared to the other parts, and when the upper and lower rolls 4, 6 are in contact with a veneer in a state where foreign matter such as dust is caught between the upper and lower rolls 4, 6 (the elastic cylindrical members 46) and a veneer (hereinafter, referred to as “second state”). The state where the elastic cylindrical members 46 of the upper and lower rolls 4, 6 are in contact with a veneer portion without a part, such as a knot, of extremely high compressive strength compared to the other parts or the state where no foreign matter such as dust is caught between the elastic cylindrical members 46 of the upper and lower rolls 4, 6 and the veneer are an example of an implemented configuration corresponding to the “first state” in the present invention. The state where the elastic cylindrical members 46 of the upper and lower rolls 4, 6 are in contact with a veneer portion with a part, such as a knot, of extremely high compressive strength compared to the other parts or the state where foreign matter such as dust is caught between the elastic cylindrical member 46 of the upper and lower rolls 4, 6 and the veneer are an example of an implemented configuration corresponding to the “second state” in the present invention.

Next, the operation of the veneer dewatering apparatus 1 of the above configuration will be described. First, the motor M1 and the motor M2 are driven to rotate the upper roll 4 and the lower roll 6 in directions opposite to each other. Subsequently, a veneer is passed between the upper roll 4 and the lower roll 6 rotating in opposite directions. The veneer is conveyed in the rotation directions of the upper roll 4 and the lower roll 6 while being compressed by the upper roll 4 and the lower roll 6.

Among the narrow rolls 22, 24, 22, 24, . . . , 22, 24 of the upper and lower rolls 4, 6, the narrow rolls 22, 24, 22, 24, . . . , 22, 24 in the first state are connected to the rotating shafts 20, 20 via the respective clutches 30. Thus, the narrow rolls 22, 24, 22, 24, . . . , 22, 24 in the first state are rotated together with the respective rotating shafts 20, 20. As a result, the narrow rolls 22, 24, 22, 24, . . . , 22, 24 in the first state compresses the veneer almost evenly, well removing the water contained in the veneer.

In contrast, among the narrow rolls 22, 24, 22, 24, . . . , 22, 24 of the upper roll 4 and the lower roll 6, the narrow rolls 22, 24, 22, 24, . . . , 22, 24 in the second state are disconnected from the respective rotating shafts 20, 20 by the respective clutches 30, 30, . . . , 30 and are rotated relative to the respective rotating shafts 20, 20. Accordingly, the deformation of the elastic cylindrical members 46, 46 of the narrow rolls 22, 24, 22, 24, . . . , 22, 24 in the second state due to the pulling force of the veneer can be well managed from exceeding the elastic region. As a result, damage of the elastic cylindrical members 46, 46 and deterioration in durability of the elastic cylindrical members 46, 46 can be well decreased. Note that, after a veneer portion with a part such as knot having extremely high compressive strength compared to the other parts has passed, or after foreign matters such as dust have passed, the narrow rolls 22, 24, 22, 24, . . . , 22, 24 which have been rotated relative to the rotating shafts 20, 20 are again connected to the rotating shafts 20, 20 by the clutches 30, 30, . . . , 30 for integral rotation. Thus, the veneer conveying function of the narrow rolls 22, 24, 22, 24, . . . , 22, 24 which have been rotated relative to the rotating shafts 20, 20 is restored.

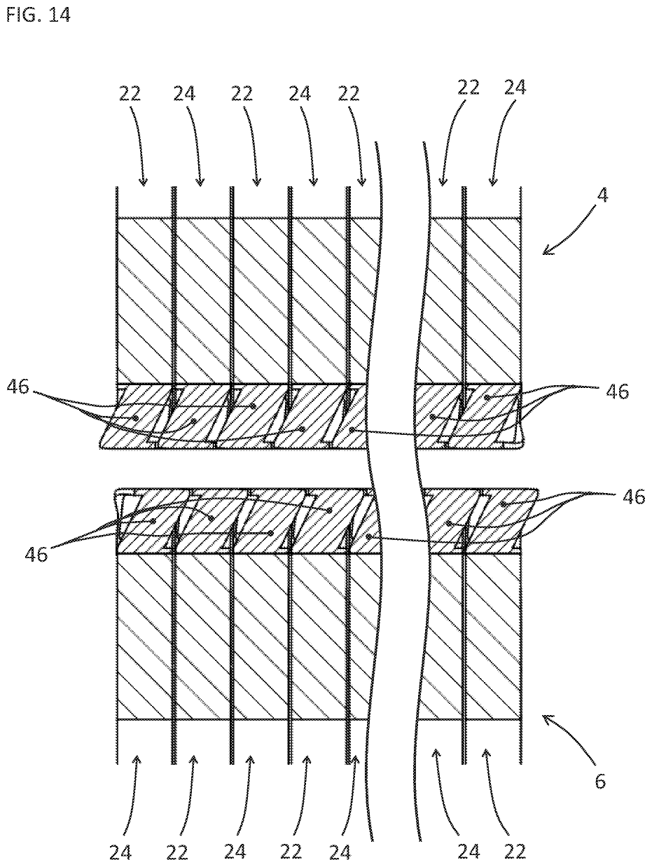

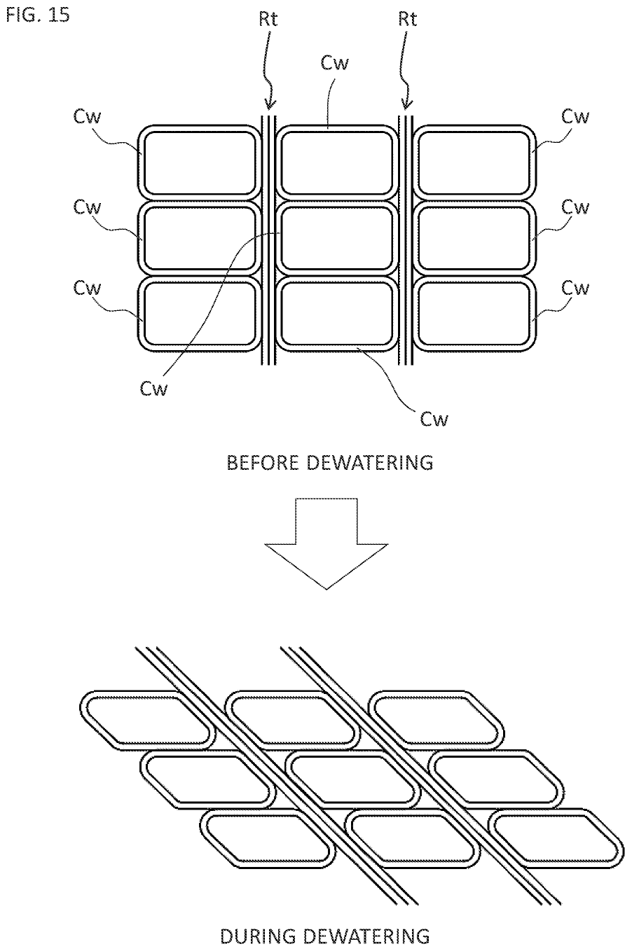

Here, in the present embodiment, the elastic cylindrical members 46, 46 each have, on one side, a substantially Z-shape cross section. Accordingly, when a veneer passes between the elastic cylindrical members 46, 46 of the upper and lower rolls 4, 6, as shown in FIG. 14, the elastic cylindrical members 46, 46 are easy to deform (easily bend) in a direction inclined relative to the direction that is orthogonal to the axis CL direction (see FIG. 6). Thereby, the veneer is compressed in the same direction as that in which the elastic cylindrical members 46, 46 are deformed. As a result, compared to a configuration in which a veneer is compressed in the direction orthogonal to the front and rear surfaces of the veneer, buckling and cracking that leads to plastic deformation of the medical rays Rt and the cell walls Cw can be less likely to occur in a veneer. Note that the elastic cylindrical members 46 of the upper roll 4 deform (bend) axially of the shaft in a direction opposite to that the elastic cylindrical members 46 of the lower roll deform (bend) along the axis CL direction. Thus, as shown in FIG. 15, the medullary rays Rt and the cell walls Cw in a veneer can be deformed into a substantially rhombic tubular shape. As a result, the medical rays Rt of a veneer can be deformed so as to be tilted (which is accompanied with bending, the bending, however, has a curvature within the elastic region), and buckling and cracking of the veneer that leads to plastic deformation of the cell walls Cw can be further decreased.

In addition, since the cross section of each elastic cylindrical member on one side is Z-shaped, the gaps in the axis CL direction (see FIG. 6) between the elastic cylindrical members 46, 46 of the narrow rolls 22, 24, 22, 24, . . . , 22, 24 can be decreased compared to a conventional configuration in which a plurality of grooves are formed on each elastic cylindrical member. As a result, tearing of a veneer can be well decreased without sacrificing the ease of deformation (flexibility) of the elastic cylindrical members 46, 46, the so-called tearing being caused when a veneer goes into a gap in the axial direction between the elastic cylindrical members 46, 46.

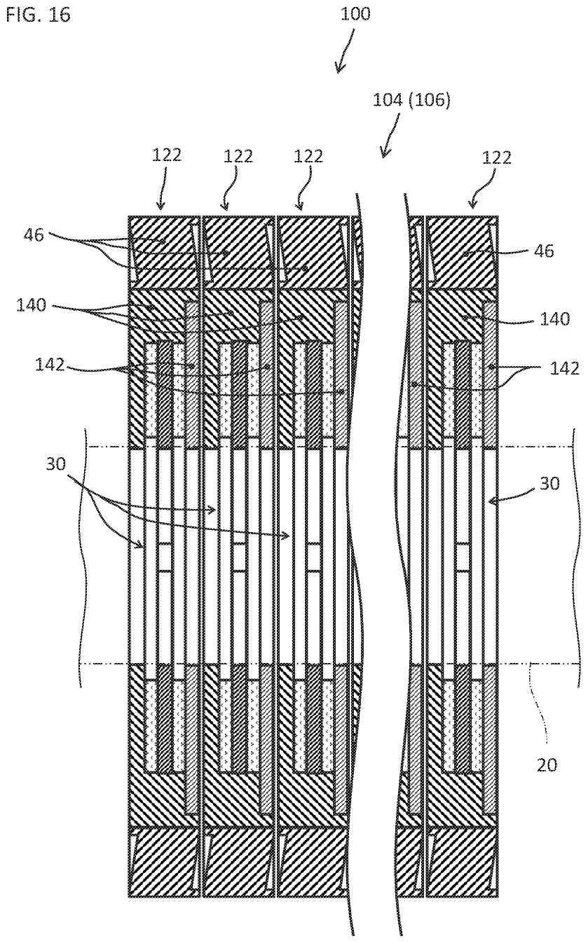

In the present embodiment, each clutch 30 is interposed between the recess 41a of the narrow roll 22 and the recess 41b of the narrow roll 24, that is, one clutch 30 is provided for a pair of narrow rolls 22 and 24. However, the present invention is not limited to the configuration. For example, as shown in a modified veneer dewatering apparatus 100 illustrated in FIG. 16, each narrow roll 122 may include one clutch 30.

The modified veneer dewatering apparatus 100 has the same configuration as the veneer dewatering apparatus 1 of the present embodiment except that the upper roll 4 and the lower roll 6 are replaced with an upper roll 104 and a lower roll 106. Accordingly, the same components as those of the veneer dewatering apparatus 1 of the present embodiment are denoted by the same reference numerals, and the description thereof will be omitted to avoid duplication.

As shown in FIG. 16, the upper roll 104 and the lower roll 106 each have a rotating shaft 20, a plurality of narrow rolls 122, 122, . . . , 122 supported by the rotating shaft 20, and a plurality of clutches 30, 30, . . . , 30. The upper roll 104 and the lower roll 106 are an example of an implemented configuration corresponding to the “first roll” and the “second roll” in the present invention, respectively.

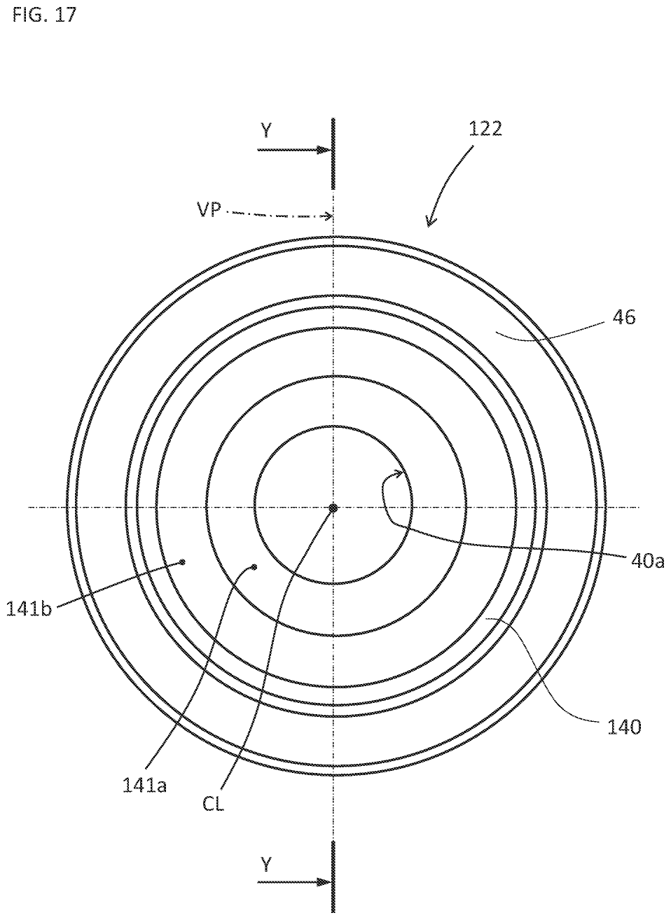

As shown in FIGS. 16 and 17, the narrow rolls 122 each include a metal cylinder 140 disposed coaxially with the rotating shaft 20 on the outer peripheral surface of the rotating shaft 20, a cover 142 attached to the cylinder 140, and the elastic cylindrical member 46 that is integral with outer peripheral surface of the cylinder 140 so as to be coaxially with the rotating shaft 20.

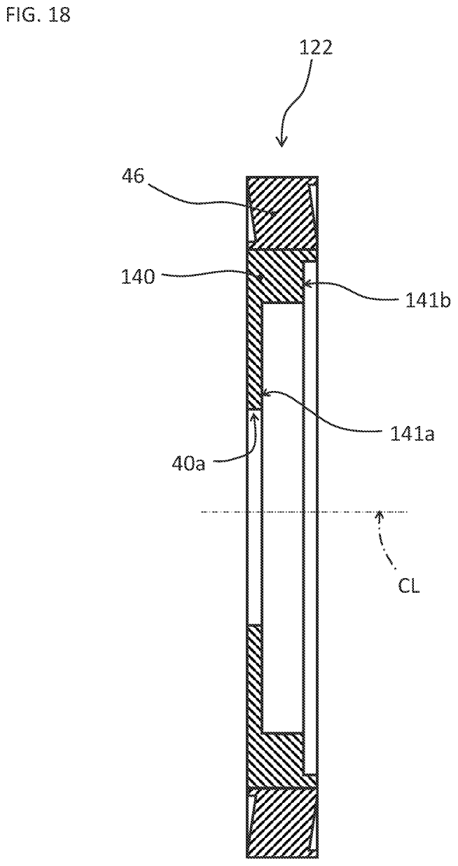

As shown in FIGS. 17 and 18, the cylinder 140 has a shaft insertion hole 40a, a recess 141a, and a recess 141b that is continuous to the recess 141a. The recesses 141a and 141b are concentric with the shaft insertion hole 40a when viewed from the front (FIG. 17). The recess 141a has an inner diameter equal to or slightly smaller than the outer diameter of the friction plate 34, and a depth dpr slightly smaller than a dimension tc of the clutch 30 in the thickness direction (a dimension obtained by adding the thickness of the disk 32 and the thickness of the two friction plates 34, 34). The recess 141b has an inner diameter and a depth, respectively, substantially equal to the outer diameter and the plate thickness of the cover 142 which will be described later. The cylinders 140, 140, . . . , 140 of the plurality of narrow rolls 122, 122, . . . , 122 arranged in series axially of the rotating shaft 20 are an example of an implemented configuration corresponding to the “first roll” and the “second roll” in the present invention.

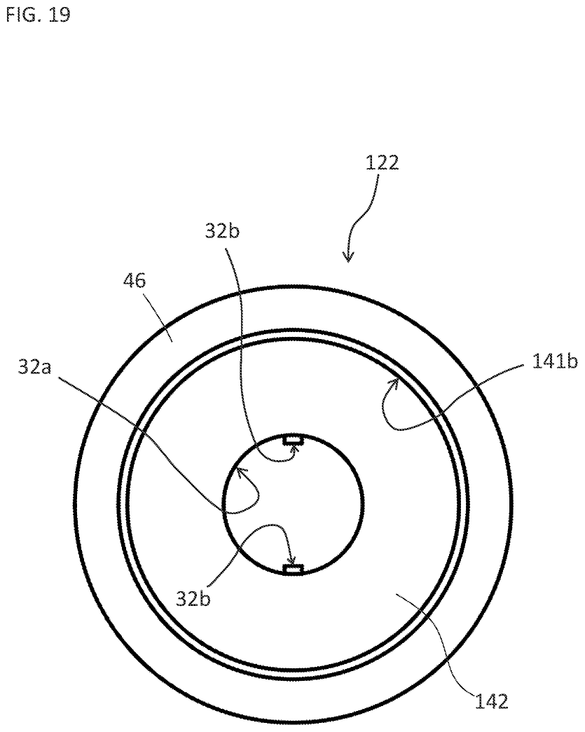

As shown in FIG. 19, the cover 142 is a metal circular plate having an outer diameter approximately the same as the inner diameter of the recess 141b and an inner diameter approximately the same as the shaft insertion hole 32a of the disk 32. The shaft insertion hole 32a has a diameter equal to or slightly larger than the outer diameter of the rotating shaft 20. By attaching the cover 142 to the recess 141b with the clutch 30 disposed in the recess 141b, the friction plates 34, 34 are compressed and pressed against the cylinder 141 and the cover 142. As a result, a predetermined axial pressing force acts on the clutch 30. Note that, when the clutch 30 is disposed in the recess 141b, the friction plates 34, 34 are in frictional contact with the recess 141a and the cover 142, and thereby the friction plates 34, 34 and the narrow roll 122 rotate together. The cover 142 is an example of an implemented configuration corresponding to the “pressing unit” in the present invention. The friction plates 34, 34, which are disposed axially on one side (the left side in FIG. 16) of the disks 32, 32, . . . , 32 on the narrow rolls 122, 122, . . . , 122, correspond to the “third friction plate” and the “fifth friction plate” in the present invention. The friction plates 34, 34, which are disposed axially on the other side (the right side in FIG. 16) of the disks 32, 32, . . . , 32 on the narrow rolls 122, 122, . . . , 122, are an example of an implemented configuration corresponding to the “fourth friction plate” and the “sixth friction plate” in the present invention.

The plurality of narrow rolls 122 of the above configuration are disposed on the rotating shafts 20, 20, so that, as shown FIG. 16, the upper roll 104 and the lower roll 106 are constructed. When the plurality of narrow rolls 122 are disposed on the rotating shafts 20, 20, the projecting pieces 32b, 32b of the disks 32, 32 are engaged with the grooves 20a, 20a of the rotating shafts 20, 20, which enables the disks 32, 32 to rotate integrally with the rotating shafts 20, 20.

The modified veneer dewatering apparatus of the above configuration which includes the upper roll 104 and the lower roll 106 provides similar effects to those of the veneer dewatering apparatus 1 of the present embodiment described above. Specifically, among the narrow rolls 122, 122, . . . , 122 of the upper roll 104 and the lower roll 106, the narrow rolls 122, 122, . . . , 122 in the first state are connected to the rotating shafts 20, 20 by the clutches 30, 30, . . . , 30, and the narrow rolls 122, 122, . . . , 122 rotate integrally with the rotating shafts 20, 20, and thereby a veneer can be compressed by the narrow rolls 122, 122, . . . , 122 almost evenly, well removing the water contained in the veneer.

In contrast, among the narrow rolls 122, 122, . . . , 122 of the upper roll 104 and the lower roll 106, the narrow rolls 122, 122, . . . , 122 in the second state are disconnected from the respective rotating shafts 20, 20 by the respective clutches 30, 30, . . . , 30 and are rotated relative to the respective rotating shafts 20, 20. As a result, the deformation of the elastic cylindrical members 46, 46 of the narrow rolls 122, 122, . . . , 122 in the second state can be well managed from exceeding the elastic region. As a result, damage of the elastic cylindrical members 46, 46 and deterioration in durability of the elastic cylindrical members 46, 46 can be well decreased. Note that, after a veneer portion with a part such as knot having extremely high compressive strength compared to the other parts has passed, or after foreign matters such as dust have passed, the narrow rolls 122, 122, . . . , 122 which have been rotated relative to the rotating shafts 20, 20 are again connected to the rotating shafts 20, 20 by the clutches 30, 30, . . . , 30 for integral rotation. Thus, the veneer conveyance function and the veneer dewatering function of the narrow rolls 122, 122, . . . , 122 which have been rotated relative to the rotating shafts 20, 20 are restored.

In the present embodiment and the modified example described above, the thickness dimension tc of the clutch 30 is set to be slightly larger than twice the depth dpr of each of the recesses 41a and 41b, and the stoppers 26, 26 are fixed to the rotating shafts 20, 20 so that the narrow rolls 22, 24, . . . , 22, 24 are sandwiched between both axial sides of the rotating shafts 20, 20, or the thickness dimension tc of the clutch 30 is set to be slightly larger than the depth dpr of the recess 141a and the cover 142 is attached to the recess 141b. Thereby, the clutches 30, 30, . . . , 30 are able to apply a predetermined axial pressing force. However, the present invention is not limited to the configuration. For example, an elastic member such as a circular plate spring may be used to apply a predetermined axial pressing force to the clutches 30, 30, . . . , 30. In this case, a configuration is possible in which the thickness dimension tc of the clutch 30 is set to be less than twice the depth dpr of each of the recesses 41a and 41b, and an elastic member such as a circular plate spring is interposed between the friction plate 34 and the recess 41a and/or between the friction plate 34 and the recess 41b. Alternatively, a configuration is possible in which the thickness dimension tc of the clutch 30 is set to be smaller than the depth dpr of the recess 141a and an elastic member such as a circular plate spring is interposed between the friction plate 34 and the recess 141a and/or between the friction plate 34 and the cover 142. Here, the circular plate spring is an example of an implemented configuration corresponding to the “connecting unit” and “pressing unit” in the present invention.

In the present embodiment and the modified example described above, the friction plates 34, 34 are attached to the disk 32, but a configuration is possible in which the friction plates 34, 34 are not attached to the disk 32.

In the present embodiment and the modified example described above, the friction plates 34, 34 are configured to directly contact the cylinders 40, 140 (the recesses 41a, 41b, 141a), but the present invention is not limited to the configuration. For example, the friction plates 34, 34 may be configured to contact the cylinders 40, 140 (the recesses 41a, 41b, 141a) via contact plates. According to the configuration, wearing of the cylinders 40, 140 (the recesses 41a, 41b, 141a) due to frictional contact with the friction plates 34, 34 can be reduced. As a result, no replacement of the cylinders 40, 140 (recesses 41a, 41b, 141a) is required, and the contact plates are the only one to be replaced, which is economical.

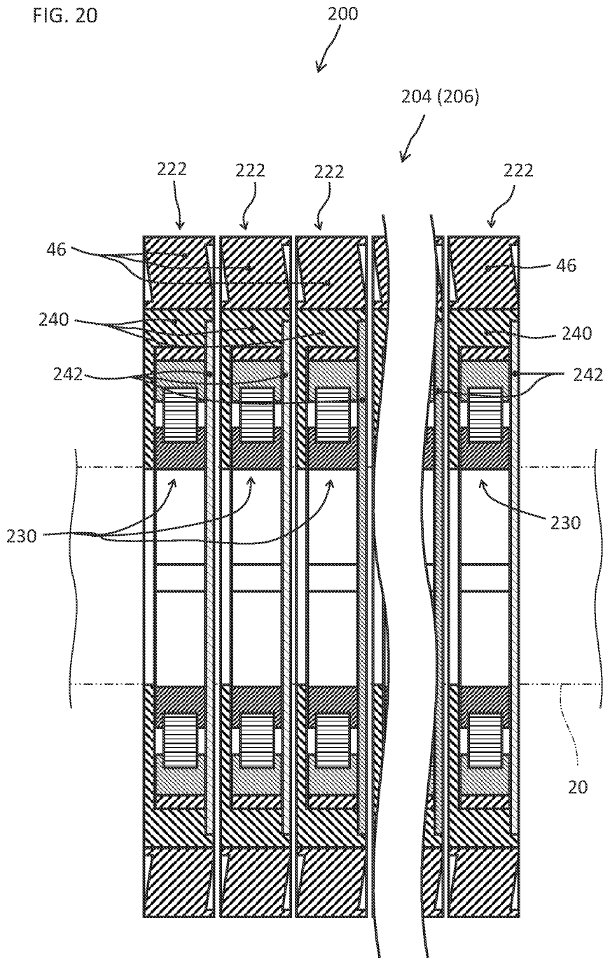

In the present embodiment and the modified example described above, the clutches 30 each having a disk 32 and a pair of friction plates 34, 34 connect and disconnect between the narrow rolls 22, 24, 122 and the respective rotating shafts 20, 20, 122, but the present invention is not limited to the configuration. For example, as shown in a modified veneer dewatering apparatus 200 illustrated in FIG. 20, clutches 230 may be used to connect and disconnect between the narrow rolls 222 and the rotating shafts 20, 20.

The modified veneer dewatering apparatus 200 has the same configuration as the modified veneer dewatering apparatus 100 described above, except that the upper roll 104 and the lower roll 106 are replaced with an upper roll 204 and a lower roll 206. Accordingly, the same components as those of the modified veneer dewatering apparatus 100 are denoted by the same reference numerals, and the description thereof will be omitted to avoid duplication.

As shown in FIG. 20, the upper roll 204 and the lower roll 206 each include a rotating shaft 20, a plurality of narrow rolls 222, 222, . . . , 222 supported by the rotating shaft 20, and a plurality of clutches 230, 230, . . . , 230. The upper roll 204 and the lower roll 206 are, respectively, an example of an implemented configuration corresponding to the “first roll” and the “second roll” in the present invention.

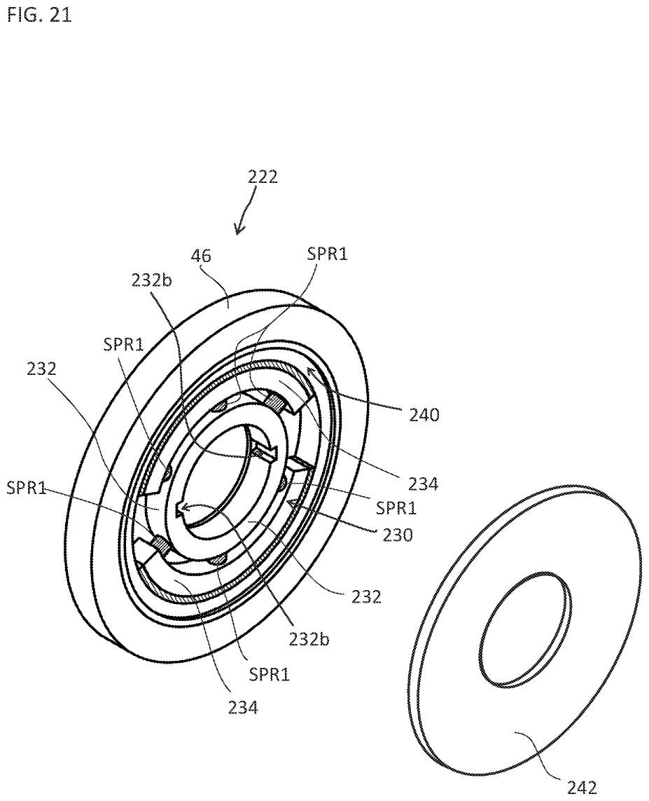

As shown in FIGS. 20 and 21, the narrow rolls 222 each include a metal cylinder 240 arranged coaxially with the rotating shaft 20 on the outer peripheral surface of the rotating shaft 20, a cover 242 (see FIG. 21) attached to the cylinder 240, and an elastic cylindrical member 46 integral with the outer peripheral surface of the cylinder 240 so as to be coaxial with the rotating shaft 20.

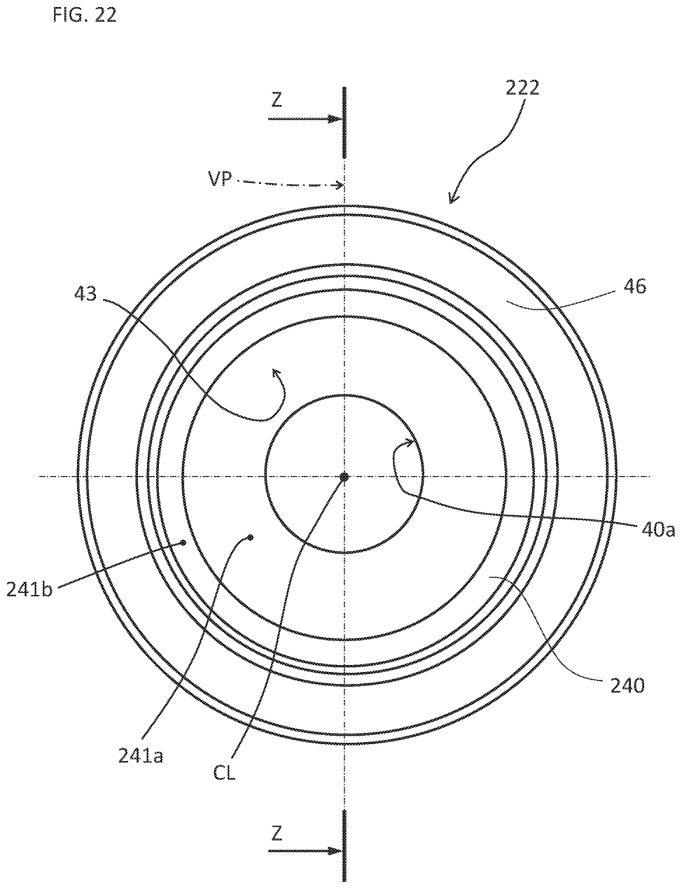

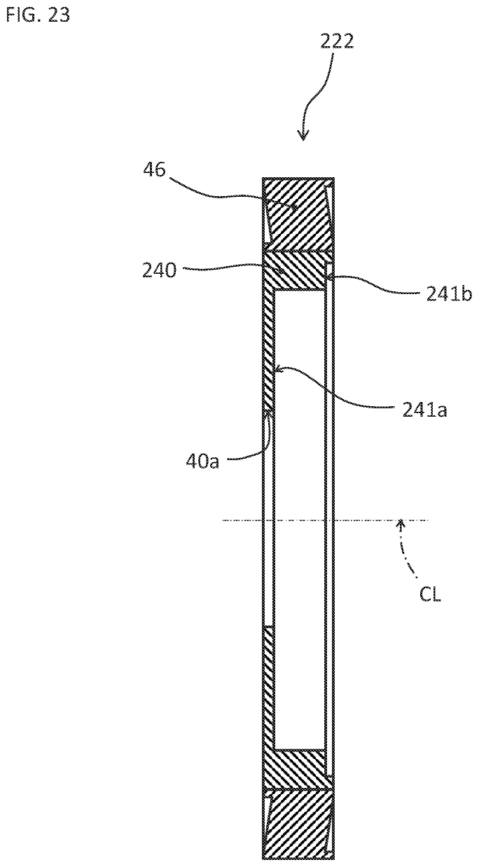

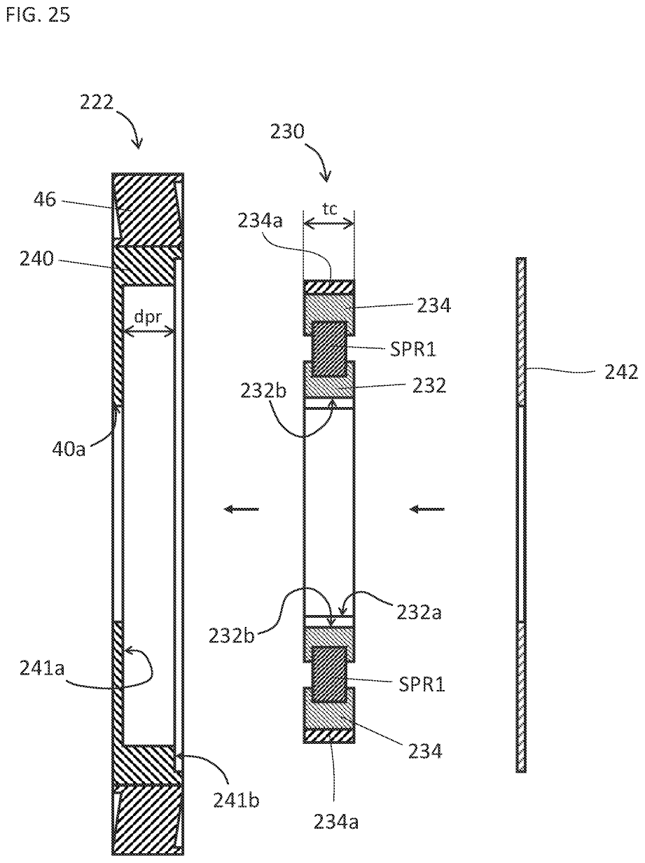

As shown in FIGS. 22 and 23, the cylinder 240 has a shaft insertion hole 40a, a recess 241a, and a recess 241b continuous with the recess 241a. The recesses 241a and 241b are concentric with the shaft insertion hole 40a when viewed from the front (FIG. 22). As shown in FIG. 25, the recess 241a has a depth dpr equal to or slightly larger than a dimension tc of the clutch 230 in the thickness direction. The recess 241a has an inner diameter and a depth dpr that are approximately the same as the outer diameter and thickness of the later-described cover 242, respectively. The cylinders 240, 240, . . . , 240 of the plurality of narrow rolls 222, 222, . . . , 222 arranged in series axially of the rotating shaft 20 are an example of an implemented configuration corresponding to the “first roll” and the “second roll” in the present invention.

As shown in FIG. 21, the cover 242 is a metal circular plate having an outer diameter and a thickness that are approximately the same as the inner diameter and the depth of the recess 241b, respectively, and having an inner diameter approximately the same as the shaft insertion hole 232a of the clutch 230 as describe below.

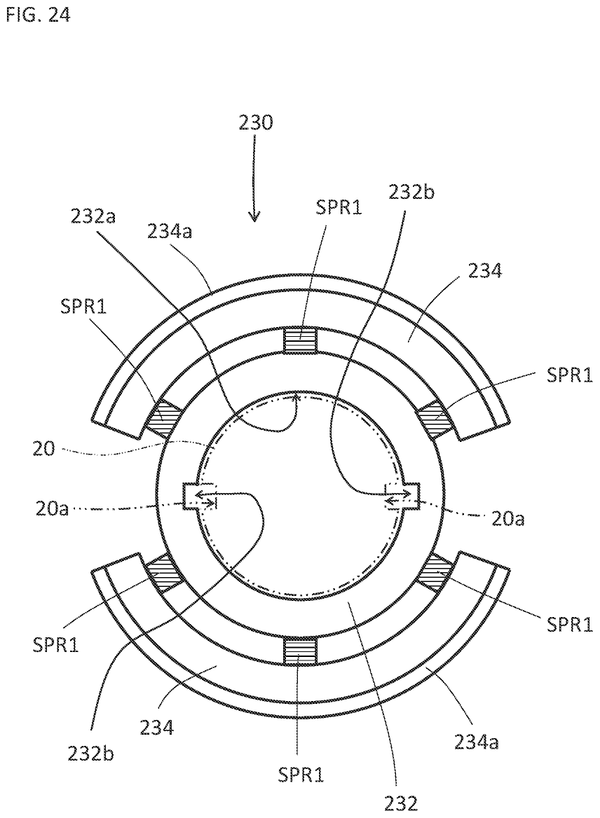

As shown in FIG. 24, the clutch 230 has a cylindrical hub 232 and two brake shoes 234, 234 that are each connected to the hub 232 via three coil springs SPR1, SPR1, SPR1. The hub 232 has a shaft insertion hole 232a through which the rotating shaft 20 can be inserted. The shaft insertion hole 232a has a diameter equal to or slightly larger than the outer diameter of the rotating shaft 20. Also, the shaft insertion hole 232a has a pair of grooves 232b, 232b. The six coil springs SPR1, SPR1, SPR1 are connected to the hub 232 so as to be rotatable together with the hub 232. Each brake shoe 234 has an outer diameter substantially equal to or slightly smaller than the inner diameter of the recess 241a, and has a friction material 234a integrally attached to its outer peripheral surface. Three coil springs SPR1, SPR1, SPR1 are connected to the inner peripheral surface of the brake shoe 234. Thereby, the brake shoes 234, 234 are each integrally rotatable with the hub 232 via the three coil springs SPR1, SPR1, SPR1. Note that the six coil springs SPR1 are evenly arranged on the outer peripheral surface of the hub 232 in the circumferential direction. Needless to say, the number of coil springs SPR1 is not limited to three, but may be two or less, or four or more. Also, the coil springs SPR1 do not have to be evenly arranged on the outer peripheral surface of the hub 232 in the circumferential direction. The clutch 230 corresponds to the “connecting unit” in the present invention, and the coil spring SPR1 is an example of an implemented configuration corresponding to the “connecting unit,” “urging unit,” “first urging unit,” “second urging unit,” and “elastic member” in the present invention. Also, the hub 232 is an example of an implemented configuration corresponding to the “cylindrical hub,” “cylindrical hub,” and “second cylindrical hub” in the present invention.

The coil spring SPR1 has various factors (e.g., a wire diameter, a free length, an effective number of turns, a pitch, a spring constant of the coil spring SPR1) that enable the brake shoes 234, 234 to be pressed against the peripheral surface of the recess 241a with a predetermined pressing force when the clutch 230 is disposed in the recess 241a of the cylinder 240. Specifically, the various factors of the coil spring SPR1 are appropriately set (adjusted) so that: the frictional force generated between the brake shoes 234, 234 and the cylinder 240 due to a predetermined pressing force becomes larger than the deformation resistance generated when the upper and lower rolls 204, 206 contact a veneer portion without a part, such as a knot, of extremely high compressive strength compared to the other parts and when the upper and lower rolls 204, 206 contact a veneer in a state foreign matter such as dust is not caught between the upper and lower rolls 204, 206 and the veneer; and the frictional force generated between the brake shoes 234, 234 and the cylinder 240 due to a predetermined pressing force becomes smaller than the deformation resistance generated when the upper and lower rolls 204, 206 contact a veneer portion with a part, such as a knot, of extremely high compressive strength compared to the other parts and when the upper and lower rolls 204, 206 contact a veneer in a state foreign matter such as dust is caught between the upper and lower rolls 204, 206 and the veneer. When the narrow roll 322 is mounted to the rotating shaft 20 with the clutch 230 being in the recess 241a of the cylinder 240, as shown in FIG. 24, the grooves 20a, 20a of the rotating shaft 20 and the grooves 232b, 232b are aligned circumferentially, and the aligned grooves 20a, 20a and grooves 232b, 232b are fitted with a key (not shown) for example. The configuration allows the rotating shafts 20, 20 and the clutches 230, 230, . . . , 230 to rotate integrally.

The modified veneer dewatering apparatus 200 configured as above also provides the effects similar to those from the veneer dewatering apparatus 1 of the present embodiment described above. Specifically, among the narrow rolls 222, 222, . . . , 222 of the upper roll 204 and the lower roll 206, the narrow rolls 222, 222, . . . , 222 in the first state are connected to the corresponding rotating shafts 20, 20 by the clutches 230, 230, . . . , 230, so that the narrow rolls 222, 222, . . . , 222 are rotated integrally with the rotating shafts 20, 20. As a result, these narrow rolls 222, 222, . . . , 222 can compress a veneer almost evenly, well removing water contained in the veneer.

In contrast, among the narrow rolls 222, 222, . . . , 222 of the upper roll 204 and the lower roll 206, the narrow rolls 222, 222, . . . , 222 in the second state are disconnected from the corresponding rotating shafts 20, 20 by the clutches 230, 230, . . . , 230 and are rotated relative to the rotating shafts 20, 20. As a result, the deformation of the elastic cylindrical members 46, 46 of the narrow rolls 222, 222, . . . , 222 in the second state can be well managed from exceeding the elastic region. As a result, damage of the elastic cylindrical members 46, 46 and deterioration in durability of the elastic cylindrical members 46, 46 can be well decreased. In addition, after a veneer portion with a part such as knot having extremely high compressive strength compared to the other parts has passed, or after foreign matters such as dust have passed, the narrow rolls 222, 122, . . . , 222 which have been rotated relative to the rotating shafts 20, 20 are again connected to the rotating shafts 20, 20 by the clutches 230, 230, . . . , 230 for integral rotation. Thus, the veneer conveyance function and the veneer dewatering function of the narrow rolls 222, 222, . . . , 222 which have been rotated relative to the rotating shafts 20, 20 are restored.

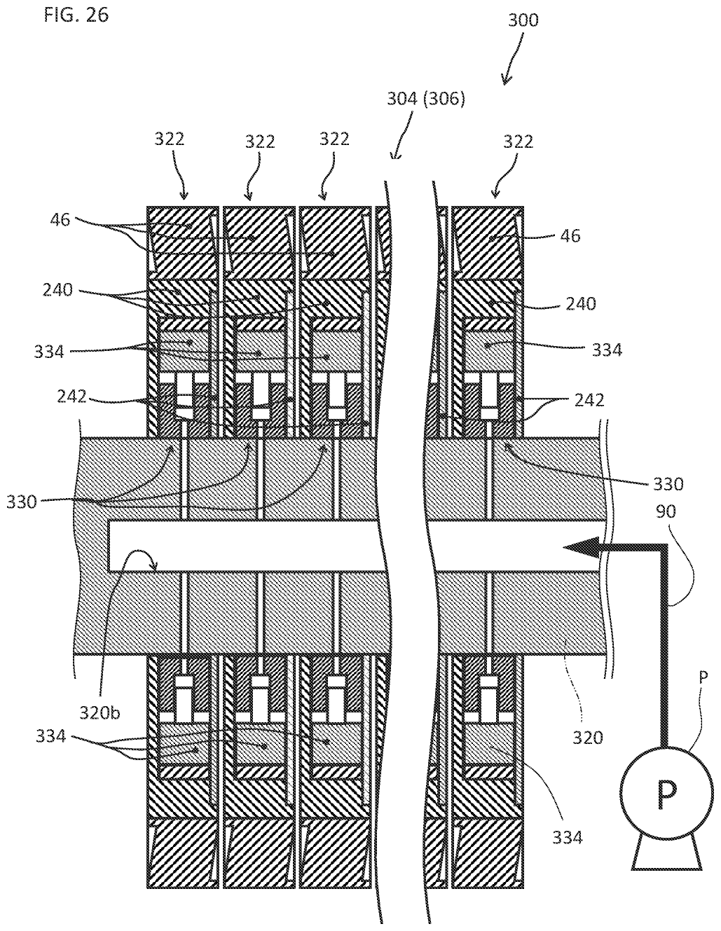

In the modified veneer dewatering apparatus 200 described above, the coil spring SPR1 is configured to press the brake shoe 234 against a peripheral surface of the recess 241a of the cylinder 240, but the present invention is not limited to the configuration. For example, as shown in a modified veneer dewatering apparatus 300 illustrated in FIG. 26, a brake shoe 334 may be pressed against the peripheral surface of the concave portion 241a of the cylinder 240 using fluid pressure.

The modified veneer dewatering apparatus 300 has the same configuration as the modified veneer dewatering apparatus 200 described above, except that the upper roll 204 and the lower roll 206 are replaced with an upper roll 304 and a lower roll 306.

Accordingly, the same components as those of the modified veneer dewatering apparatus 200 are denoted by the same reference numerals, and the description thereof will be omitted to avoid duplication.

As shown in FIG. 26, the upper roll 304 and the lower roll 306 each include a rotating shaft 320, a plurality of narrow rolls 322, 322, . . . , 322 supported by the rotating shaft 320, and a plurality of clutches 330, 330, . . . , 330. The upper roll 304 and the lower roll 306 are, respectively, an example of an implemented configuration corresponding to the “first roll” and the “second roll” in the present invention. The rotating shaft 320 is an example of an implemented configuration corresponding to the “shaft” in the present invention.

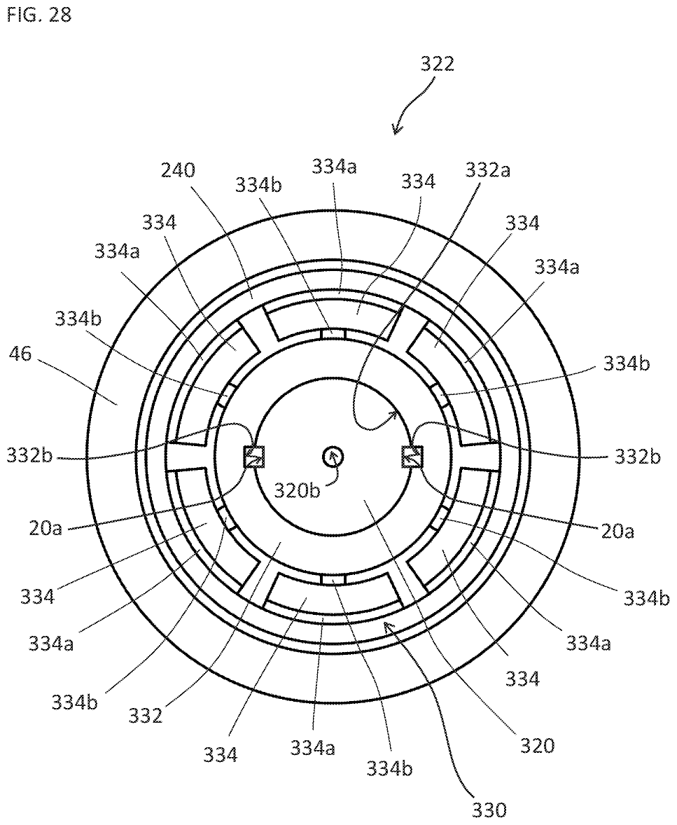

The rotating shaft 320 of the upper roll 304 and the rotating shaft 320 of the lower roll 306 are connected to the motors M1 and M2 (see FIGS. 1 and 2), respectively. As shown in FIG. 28, the rotating shafts 320, 320 each have two grooves 20a, 20a on the outer peripheral surface, an in-shaft flow path 320b extending axially, and radial flow channels 320c, 320c, 320c, 320c, 320c, 320c radially penetrating the in-shaft flow path 320b. The grooves 20a, 20a are evenly arranged circumferentially of the rotating shafts 320, 320 and extend axially of the rotating shafts 320. As shown in FIG. 26, the in-shaft flow path 320b is connected via a pipe 90 to a discharge port (not shown) of a pump P that is configured to apply fluid pressure. As shown in FIG. 26, the six radial flow channels 320c, 320c, 320c, 320c, 320c, 320c are evenly arranged circumferentially of the rotating shafts 320, 320 and arranged with a predetermined interval therebetween axially of the rotating shafts 320. Note that, the predetermined interval is set to be equal to the interval between the narrow roll 322, 322, . . . , 322, that is, the distance between stepped holes 333, 333, . . . , 333 of the clutches 330, 330, . . . , 330 which will be described below.

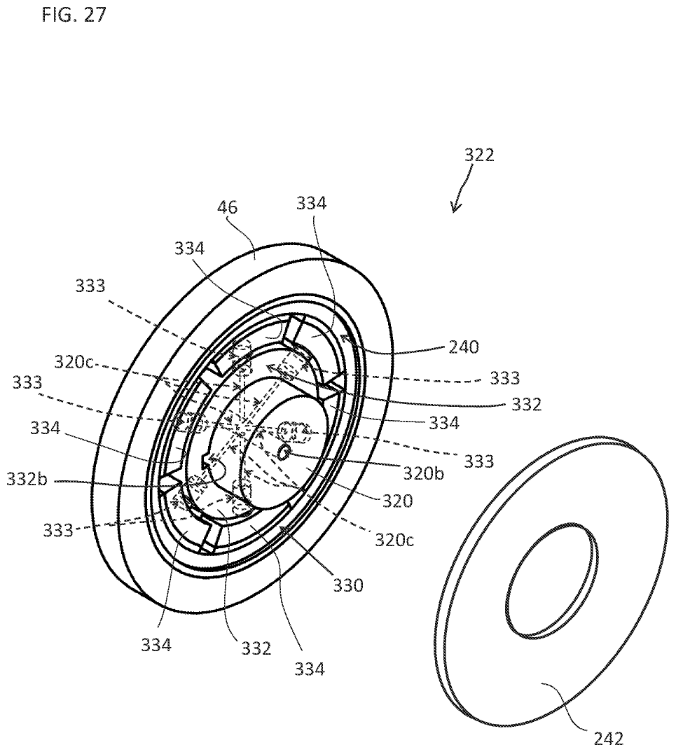

As shown in FIGS. 26 and 27, the narrow roll 322 includes a metal cylinder 240 arranged coaxially with the rotating shaft 320 on the outer peripheral surface of the rotating shaft 320, a cover 242 (see FIG. 27) attached to the cylinder 240, and an elastic cylindrical member 46 integral with the outer peripheral surface of cylinder 240 so as to be coaxially with the rotating shaft 320.

As shown in FIG. 28, the clutch 330 includes a cylindrical hub 332, and six brake shoes 334, 334, 334, 334, 334, 334 disposed on the outer periphery of the nub 332.

Note that, the number of the brake shoes 334 is not limited to six, but may be five or less, or seven or more.

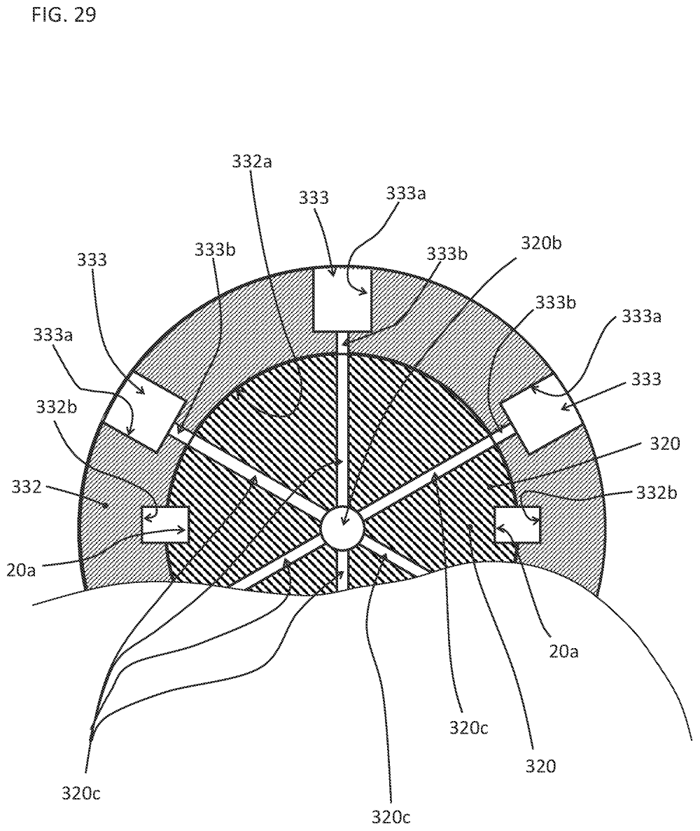

As shown in FIG. 29, the hub 332 has a shaft insertion hole 332a through which the rotating shaft 320 can be inserted, and six stepped holes 333, 333, 333, 333, 333, 333 that radially pass through the hub 332. The shaft insertion hole 332a has a diameter equal to or slightly larger than the outer diameter of the rotating shaft 20. Also, the shaft insertion hole 332a has a pair of grooves 332b, 332b. The stepped holes 333, 333, 333, 333, 333, 333 each include larger holes 333a, 333a, 333a, 333a, 333a, 333a that are radially outwardly open, and smaller holes 333b, 333b, 333b, 333b, 333b, 333b that are radially inwardly open. The smaller holes 333b, 333b, 333b, 333b, 333b, 333b have a diameter that is substantially equal to the diameter of the radial flow paths 320c, 320c, 320c, 320c, 320c, 320c of the rotating shaft 320. The stepped holes 333, 333, 333, 333, 333, 333 are evenly arranged circumferentially of the hub 332. The hub 332 is an example of an implemented configuration corresponding to the “cylindrical hub,” “first cylindrical hub,” and “second cylindrical hub” in the present invention. The stepped hole 333 is an example of an implemented configuration corresponding to the “urging unit,” “first urging unit” and “second urging unit” in the present invention.

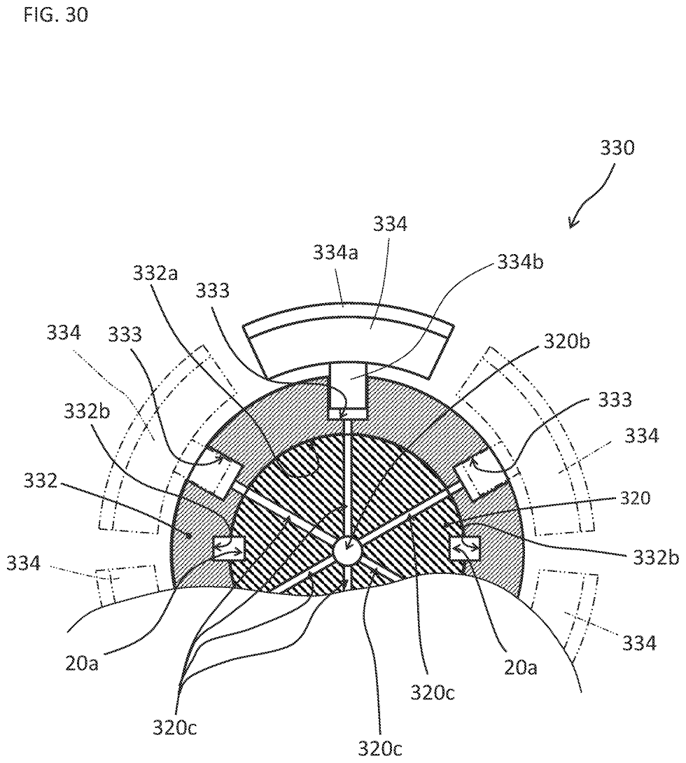

As shown in FIG. 30, the brake shoe 334 has a friction material 334a attached to its outer peripheral surface, and has a columnar projection 334b on its inner peripheral surface. The projection 334b has an outer diameter that is substantially equal to the inner diameter of the larger hole 333a of the stepped hole 333. The brake shoe 334 is an example of an implemented configuration corresponding to the “friction member,” “first friction member” and “second friction member” in the present invention.

As shown in FIG. 30, the clutch 330 of the above configuration is inserted into the recess 241a of the cylinder 240 with the projections 334b, 334b, 334b, 334b, 334b, 334b being in the larger holes 333a, 333a, 333a, 333a, 333a, 333a, respectively. When the narrow roll 322 is mounted to the rotating shaft 320 with the clutch 330 being in the recess 241a, as shown in FIG. 28, the grooves 20a, 20a of the rotating shaft 20 and the grooves 332b, 332b of the hub 332 are aligned circumferentially, and the aligned grooves 20a, 20a and grooves 332b, 332b are fitted with a key (not shown) for example. The configuration allows the rotating shafts 20, 20 and the clutches 330, 330, . . . , 330 to rotate integrally.

As shown in FIG. 26, the narrow rolls 322, 322, . . . , 322 are arranged on the rotating shafts 320, 320 such that the stepped holes 333, 333, . . . , 333 of the clutches 330, 330, . . . , 330 are aligned with the radial flow paths 320c, 320c, 320c, 320c, 320c, 320c of the rotating shafts 320, 320 in the axial direction. When the grooves 20a, 20a of the rotating shaft 320 are aligned circumferentially with the grooves 232b, 232b of the hub 232, as shown in FIGS. 29 and 30, the radial flow paths 320c, 320c, 320c, 320c, 320c, 320c of the rotating shaft 320 are aligned with the smaller holes 333b, 333b, 333b, 333b, 333b, 333b of the hub 232, respectively, in the circumferential direction. That is, the radial flow paths 320c, 320c, 320c, 320c, 320c, 320c are in communication connection with the smaller holes 333b, 333b, 333b, 333b, 333b, 333b. The clutch 330, the in-shaft flow path 320b, and the radial flow path 320c are each an example of an implemented configuration corresponding to the “connecting unit” in the present invention. The in-shaft flow path 320b corresponds to the “urging unit” and the “flow path” in the present invention, and the radial flow path 320c is an example of an implemented configuration corresponding to the “urging unit,” “first urging unit,” “second urging unit” and “first radial through-hole” in the present invention.

In the modified veneer dewatering apparatus 300 assembled as described above, at the start of operation, the pump P is driven, and a fluid pressure acts on the brake shoes 334, 334, . . . , 334 of the narrow rolls 322, 322, . . . , 322 via the pipe 90, the in-shaft flow path 320b, the radial flow paths 320c, 320c, . . . , 320c and the stepped holes 333, 333, . . . , 333. Accordingly, the brake shoes 334, 334, . . . , 334 (the friction materials 334a, 334a, . . . , 334a) are pressed against the peripheral surfaces of the recesses 241a, 241a, . . . , 241a of the narrow rolls 322, 322, . . . , 322 with a predetermined pressing force. Here, the discharge pressure of pump P is controlled such that: (i) the frictional force generated between the brake shoe 334 and the cylinder 240 due to the predetermined pressing force is greater than the pulling force of a veneer in the first state (i.e., the frictional force between the veneer and the upper roll 304 and the lower roll 306 (the elastic cylindrical members 46)), and (ii) the frictional force generated between the brake shoe 334 and the cylinder 240 due to the predetermined pressing force is smaller than the pulling force of a veneer in the second state (i.e., the frictional force between a veneer and the upper roll 304 and the lower roll 306 (the elastic cylindrical members 46)).

The modified veneer dewatering apparatus 300 configured as above also provides the effects similar to those from the veneer dewatering apparatus 1 of the above present embodiment and the modified veneer dewatering apparatuses 100, 200.

Note that a configuration is possible in which a valve is mounted for supplying a fluid and for stopping of the supply to the stepped holes 333, 333, . . . , 333 of the narrow rolls 322, 322, . . . , 322 individually. The configuration enables the narrow rolls 322, 322, . . . , 322 to be connected to and disconnected from the rotating shafts 320, 320 of the narrow rolls 322, 322, . . . , 322 by unit of the narrow rolls 322, 322, . . . , 322 as desired (by choice). In addition, the pressing force can be applied by the brake shoes 334, 334, . . . , 344 by unit of the narrow rolls 322, 322, . . . , 322 as desired (by choice). The configuration makes the veneer dewatering apparatus well adaptable to any number, size, and stiffness of knots and foreign matters present on a veneer, or to any species and thickness of the veneer.

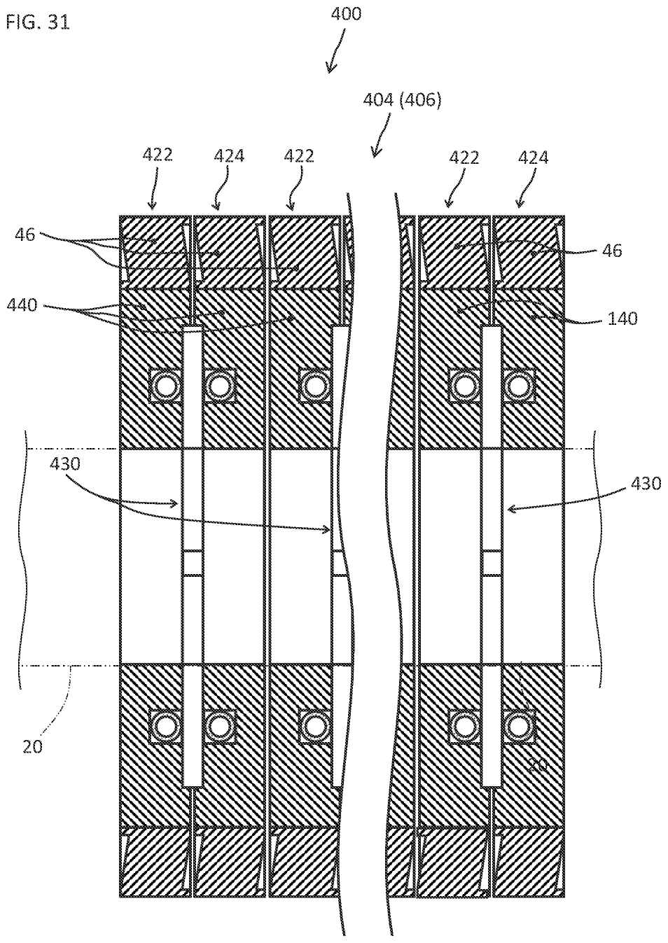

In the veneer dewatering apparatus 1 according to the present embodiment and the modified veneer dewatering apparatuses 100, 200, 300 described above, the friction clutches 30, 230, 330 connect and disconnect between the rotating shafts 20, 20, 320, 320 and the narrow rolls 22, 122, 222, 322, but the present invention is not limited to the configuration. For example, as shown in a veneer dewatering apparatus 400 illustrated in FIG. 31, a rotary clutch 430 may be used to connect and disconnect between the rotating shaft 20 and a narrow roll 422.

A modified veneer dewatering apparatus 400 has the same configuration as the veneer dewatering apparatus 1 of the embodiment described above, except that the upper roll 4 and the lower roll 6 are replaced with an upper roll 404 and a lower roll 406. Accordingly, the same components as those of the veneer dewatering apparatus 1 are denoted by the same reference numerals, and the description thereof will be omitted to avoid duplication.

As shown in FIG. 31, the upper roll 404 and the lower roll 406 each include a rotating shaft 20, a plurality of narrow rolls 422, 424, . . . , 422, 424 supported by the rotating shaft 20, and a plurality of clutches 430, 430, . . . , 430. The upper roll 404 and the lower roll 406 are respectively an example of an implemented configuration corresponding to the “first roll” and the “second roll” in the present invention.

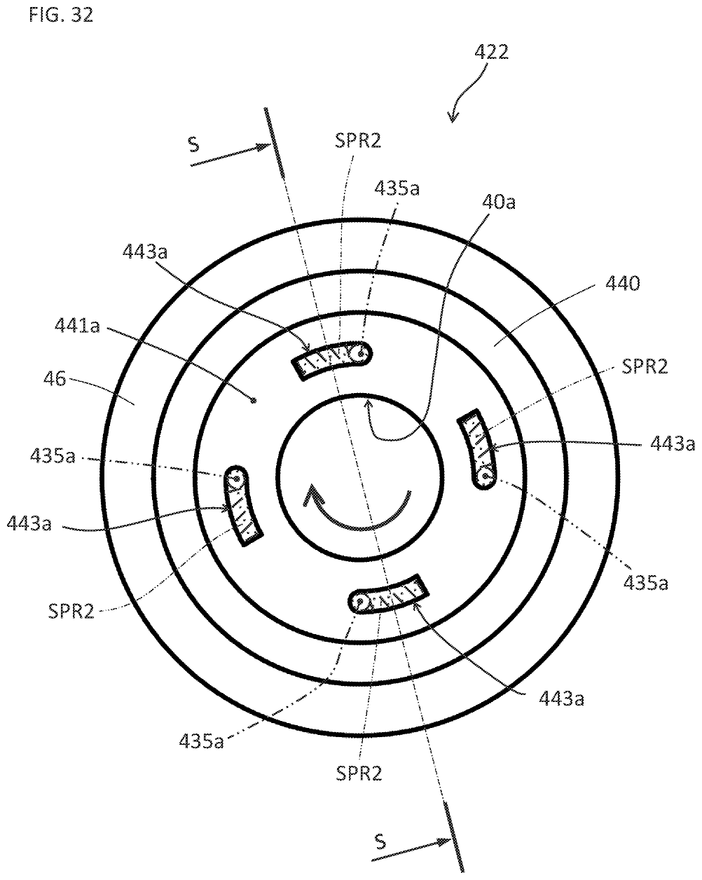

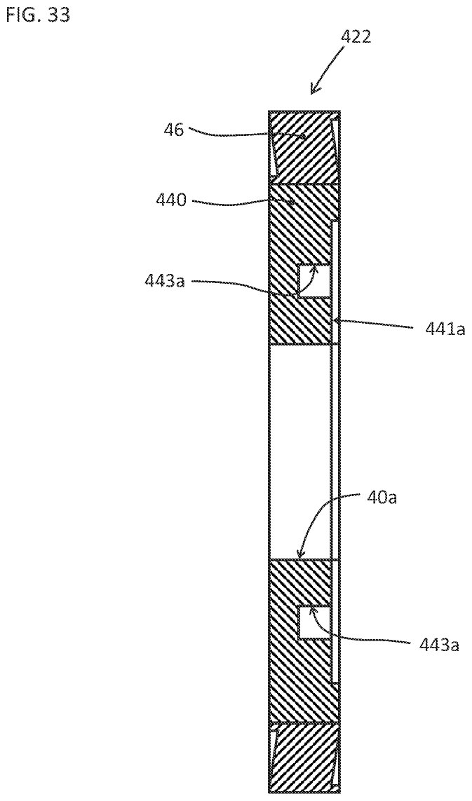

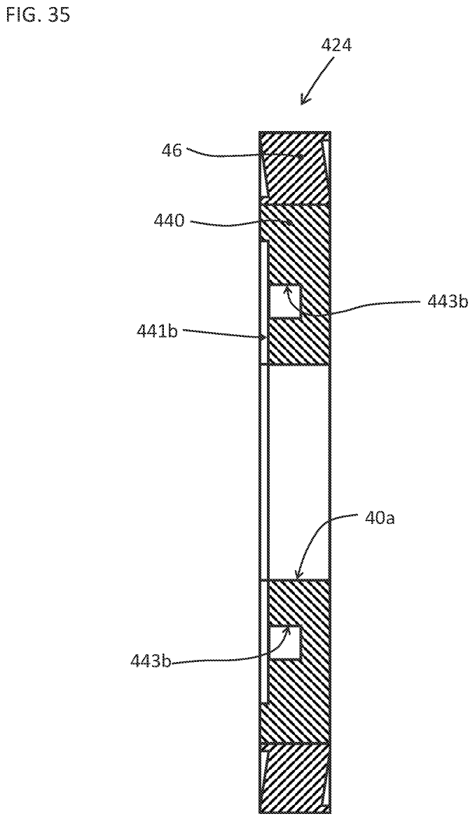

As shown in FIGS. 32 to 35, the narrow rolls 422, 424 have basically an identical configuration except that the later-described recesses 441a, 441b and the arch grooves 443a, 443a, 443a, 443a, 443b, 443b, 443b, 443b are open in different directions. Thus, the narrow roll 422 will be mainly described below. The recess 441a and the circular arc grooves 443a, 443a, 443a, 443a are open rightward in FIGS. 31 and 33, whereas the recess 441b and the circular arc grooves 443a, 443a, 443a, 443a are open leftward in FIGS. 31 and 35. As shown in FIG. 31, the narrow rolls 422 and 424 are arranged so that the recesses 441a and 441b face each other with the clutch 430 interposed therebetween.

As shown in FIG. 31, the narrow roll 422 includes a metal cylinder 440 arranged coaxially with the rotating shaft 20 on the outer peripheral surface of the rotating shaft 20 and an elastic cylindrical member 46 disposed integral with the outer peripheral surface of the cylinder 440 so as to be coaxial with the rotating shaft 20.

As shown in FIGS. 32 to 35, the cylinder 440 includes a shaft insertion hole 40a, a recess 441a (a recess 441b in the narrow roll 424), and four circular arc grooves 443a, 443a, 443a, 443a (four circular grooves 443b, 443b, 443b, 443b in the narrow roll 424). The cylinders 440, 440, . . . , 440, 440 of the plurality of narrow rolls 422, 424, . . . , 422, 424 serially arranged axially of the rotating shaft 20 are an example of an implemented configuration corresponding to the “first cylinder” and the “second cylinder” in the present invention. The circular arc grooves 443a, 443b are respectively an example of an implemented configuration corresponding to the “first circular arc groove” and the “second circular arc groove” in the present invention.

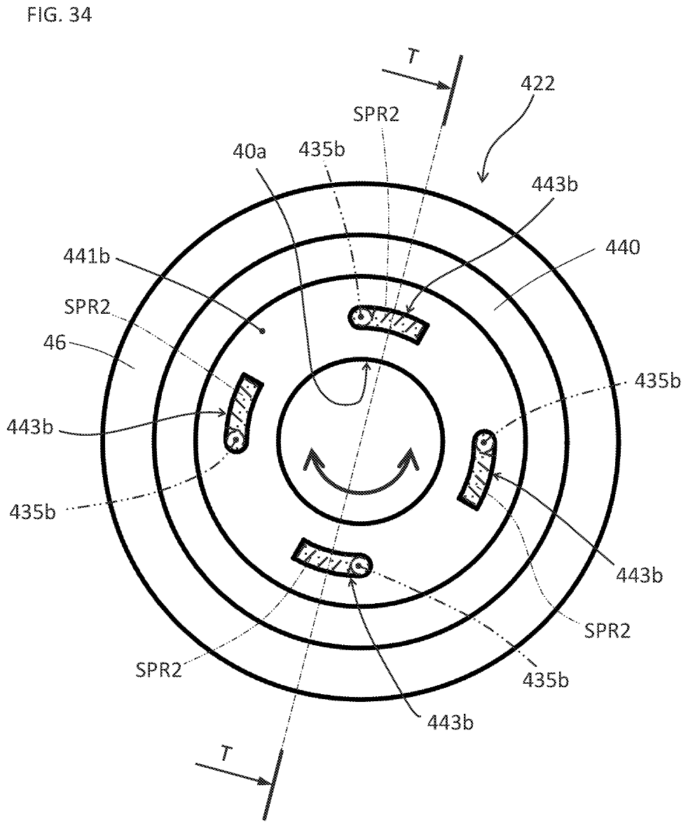

The recess 441a (the recess 441b) is concentric with the shaft insertion hole 40a when viewed from the front (FIG. 32). The recess 441a (the recess 441b) has a depth smaller than the thickness dimension of the circular plate 432 of the clutch 430 which will be described later. The circular arc grooves 443a, 443a, 443a, 443a (the four circular arc grooves 443b, 443b, 443b, 443b in the narrow roll 424) are arranged evenly in the circumferential direction at the substantially center position in the radial direction of the recess 441a (the recess 441b), as shown in FIGS. 32 and 34. The circular arc grooves 443a, 443a, 443a, 443a (the four circular arc grooves 443b, 443b, 443b, 443b in the narrow roll 424) each have a circular arc surface at its front circumferential end in the direction of rotation of the rotating shafts 20, 20 (the direction of the arrows in FIGS. 32 and 34), and a flat surface at its rear circumferential end in the direction of rotation of the rotating shafts 20, 20 (in the direction of the arrows in FIGS. 32 and 34). Here, the circular arc surface has a diameter equal to or slightly larger than the diameter of pins 435a, 435b of clutch 430, which will be described later. Note that, in the present modification, each circular arc grooves 443a has a flat surface at its rear circumferential end in the direction of rotation of the rotating shafts 20, 20 (in the direction of the arrows in FIGS. 32 and 34), but the present invention is not limited to the configuration. For example, a configuration is possible in which the circular arc grooves 443a each have a hole (into which the coil spring SPR2 can be fitted) at rear circumferential end in the direction of rotation of the rotating shafts 20, 20 (the direction of the arrows in FIGS. 32 and 34), the hole having an inner diameter that is substantially equal to the outer diameter of the coil spring SPR1, or a configuration is possible in which a pin having an outer diameter that is substantially equal to the inner diameter of the coil spring SPR2 stands on each circular arc groove 443a.

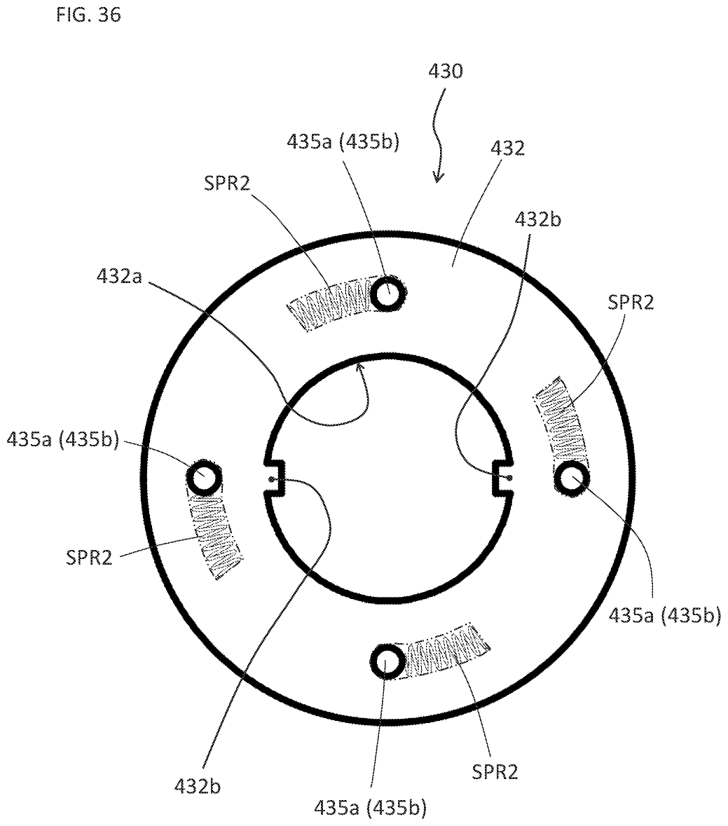

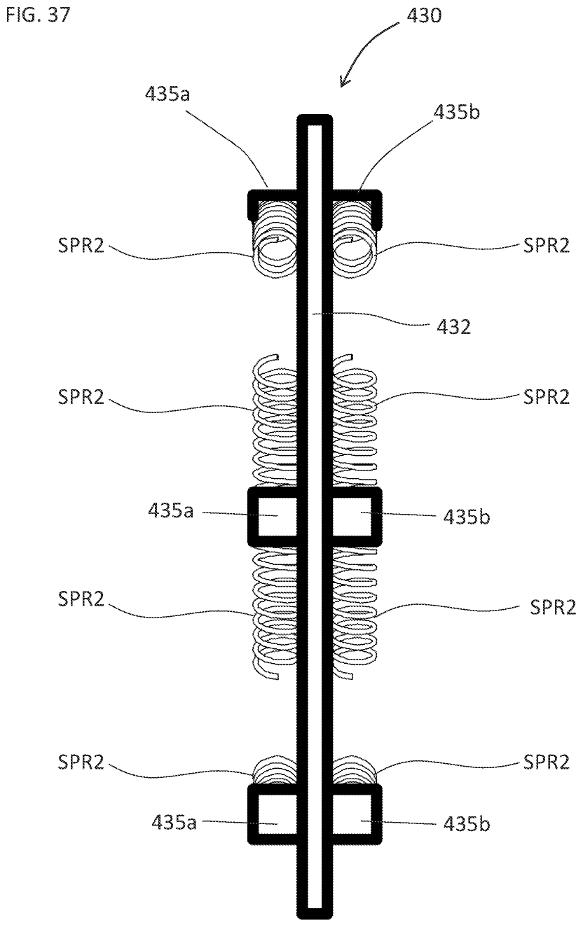

As shown in FIGS. 36 and 37, the clutch 430 includes a metal circular plate 432 having pins 435a, 435a, 435a, 435a, 435b, 435b, 435b, 435b protruding from both sides of the plate 432, and coil springs SPR2, SPR2, SPR2, SPR2, SPR2, SPR2, SPR2, SPR2 arranged to contact the pins 435a, 435a, 435a, 435a, 435b, 435b, 435b, 435b, respectively. The clutch 430 is an example of an implemented configuration corresponding to the “connecting unit” in the present invention. The circular plate 432 is an example of an implemented configuration corresponding to the “first circular plate” and the “second circular plate” in the present invention. The pins 435a, 435b correspond to the “projection” in the present invention: the pin 435a corresponds to the “first projection,” and the pin 435b is an example of an implemented configuration corresponding to the “second projection” in the present invention. The coil spring SPR2 is an example of an implemented configuration corresponding to the “urging unit,” the “first urging unit” and the “second urging unit” in the present invention.

The circular plate 432 has a shaft insertion hole 432a in the center, as shown in FIG. 36. The shaft insertion hole 432a has a diameter equal to or slightly larger than the outer diameter of the rotating shaft 20. The circular plate 432 also has a pair of projecting pieces 432b, 432b. The projecting pieces 432b, 432b protrude from the inner peripheral surface of the circular plate 432 (the shaft insertion hole 432a) toward the center of the shaft insertion hole 432a. The projecting pieces 432b, 432b are arranged evenly in the circumferential direction of the shaft insertion hole 432a. The pins 435a, 435a, 435a, 435a and the pins 435b, 435b, 435b, 435b are evenly arranged circumferentially so as to be at the same positions in the circumferential direction, respectively.

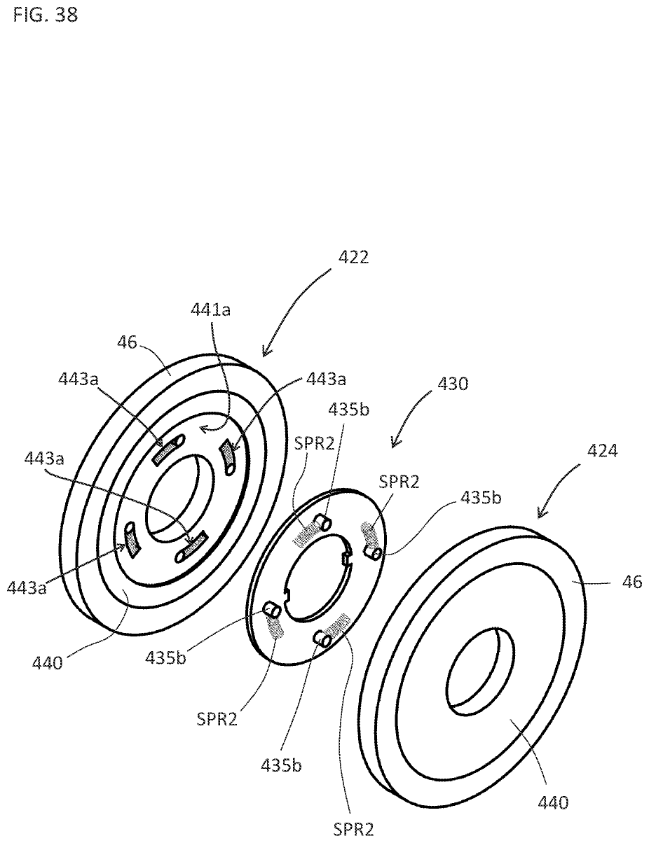

As shown in FIG. 38, the clutch 430 of the above configuration is interposed between the narrow rolls 422, 424. Specifically, the clutch 430 is disposed in the space constituted by the recess 441a of the cylinder 440 of the narrow roll 422 and the recess 441b of the cylinder 440 of the narrow roll 424. Here, as shown in FIGS. 32 and 34, the four pins 435a, 435a, 435a, 435a and the four coil springs SPR2, SPR2, SPR2, SPR2 are accommodated in the circular arc grooves 443a, 443a, 443a, 443a of the recess 441a, respectively, and the four pins 435b, 435b, 435b, 435b and the four coil springs SPR2, SPR2, SPR2, SPR2 are accommodated in the arc grooves 443b, 443b, 443b, 443b of the recess 441b, respectively. The pins 435a, 435a, 435a, 435a and the pins 435b, 435b, 435b, 435b are disposed on the circular arc surfaces of the circular arc grooves 443a, 443a, 443a, 443a and the circular arc grooves 443b, 443b, 443b, 443b, respectively. While, the coil springs SPR2, SPR2, SPR2, SPR2, SPR, SPR, SPR, SPR are disposed on the flat surfaces of the circular arc grooves 443a, 443a, 443a, 443a and the circular arc grooves 443b, 443b, 443b, 443b, respectively. With the configuration, the pins 435a, 435a, 435a, 435a and the pins 435b, 435b, 435b, 435b are urged by the coil springs SPR2, SPR2, SPR2, SPR2, in the circular arc grooves 443a, 443a, 443a, 443a and the circular arc grooves 443b, 443b, 443b, 443b, against the circular arc surfaces, respectively.

As shown in FIG. 31, in the modified veneer dewatering apparatus 400, the narrow rolls 422, 424 having the clutch 430 interposed between the recesses 441a, 441b is defined as one set, and a plurality of sets of the narrow rolls 422, 424 . . . , 422, 424 are disposed on the rotating shafts 20, 20. Here, the projecting pieces 432b, 432b of the circular plates 432, 432 of the clutch 430 are engaged with the grooves 20a, 20a of the rotating shafts 20, 20, which enables the clutch 430 to rotate with the rotating shafts 20, 20 integrally.

Next, the operation of the veneer dewatering apparatus 400 of the above configuration. The coil springs SPR2, SPR2, SPR2, SPR2, SPR2, SPR2, SPR2, SPR2 press the pins 435a, 435a, 435a, 435a and the pins 435b, 435b, 435b, 435b against the circular arc surfaces of the circular arc grooves 443a, 443a, 443a, 443a and the circular arc grooves 443b, 443b, 443b, 443b, so that the narrow rolls 422, 424, 422, 424, . . . , 422, 424 in the first state, among the narrow rolls 422, 424, 422, 424, . . . , 422, 424 of each of the upper roll 40 and the lower roll 406, are brought into connection to the rotating shafts 20, 20. Thus, the narrow rolls 422, 424, 422, 424, . . . , 422, 424 in the first state are rotated with rotating shafts 20, 20 integrally. As a result, the narrow rolls 422, 424, 422, 424, . . . , 422, 424 in the first state compresses a veneer substantially evenly, well removing water contained in the veneer.

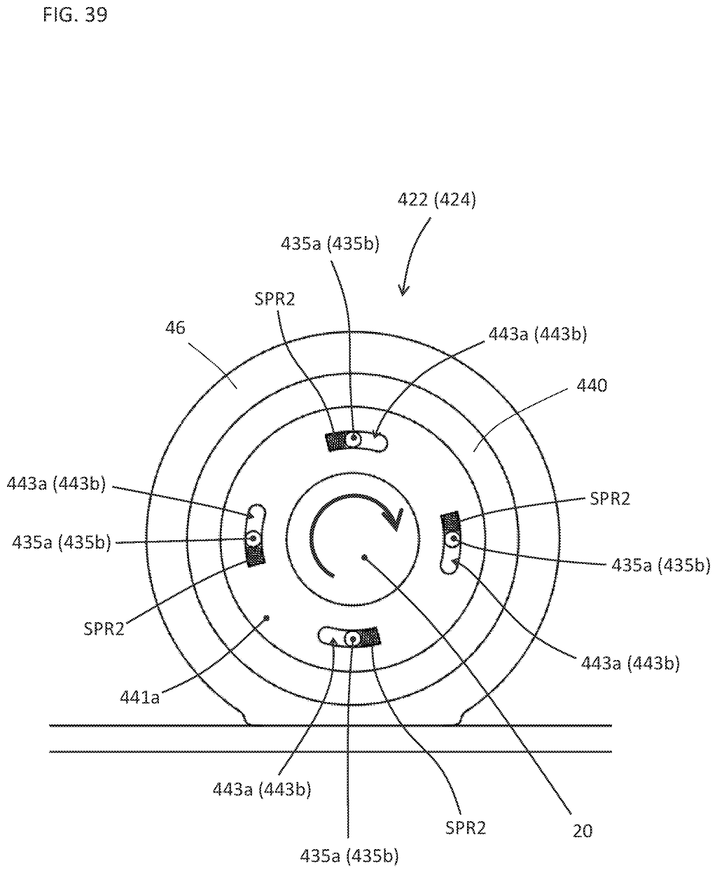

In contrast, among the narrow rolls 422, 424, 422, 424, . . . , 422, 424 of each of the upper roll 404 and the lower roll 406, the narrow rolls 422, 424, 422, 424, . . . , 422, 424 in the second state are pulled by a veneer in the conveyance direction of the veneer, and as shown in FIG. 39, the narrow rolls 422, 424, 422, 424, . . . , 422, 424 in the second state rotate in advance of the pins 435a, 435a, 435a, 435a and the pins 435b, 435b, 435b, 435b while compressing the coil springs SPR2, SPR2, SPR2, SPR2, SPR2, SPR2, SPR2, SPR2.

With the configuration, the narrow rolls 422, 424, 422, 424, . . . , 422, 424 in the second state are released from the connection to the rotating shafts 20, 20 by the respective clutches 430, 430, . . . , 430, so as to rotate relative to the rotating shafts 20, 20. As a result, the elastic cylindrical members 46, 46 of the narrow rolls 422, 424, 422, 424, . . . , 422, 424 in the second state do not deform to a degree beyond the elastic region, which can limit the damage of the elastic cylindrical members 46, 46 and deterioration in durability of the elastic cylindrical members 46, 46.

In the modified veneer dewatering apparatus 400, the clutch 430 operates upon occurrence of a peripheral speed difference in the narrow rolls 422, 424, and thereby the load on the elastic cylindrical members 46, 46 of the narrow rolls 422, 424 can be reduced compared to the case with the friction type clutches 30, 230, 330 of the veneer dewatering apparatuses 1 of the above embodiment and the above-described modified veneer dewatering apparatuses 100, 200, 300.

In the present embodiment and the above modifications, the upper rolls 4, 104, 204, 304, 404 are driven to rotate by the motor M1, and the lower rolls 6, 106, 206, 306, 406 are driven to rotate by the motor M2, but the present invention is not limited to the configuration. For example, a configuration is possible in which only the upper rolls 4, 104, 204, 304, 404 are driven to rotate by the motor M1, or a configuration is possible in which only the lower rolls 6, 106, 206, 306, 406 are driven to rotate by the motor M2. In this case, a chain may be used to transmit the power of the motor M1 or the motor M2 to the rolls that are not connected to the motor M1 or the motor M2 (the upper rolls 4, 104, 204, 304, 404 or the lower rolls 6, 106, 206, 306, 406). Note that the present invention is applicable to the upper rolls 4, 104, 204, 304, 404 and the lower rolls 6, 106, 206, 306, 406 that are driven to rotate by the motor M1 and/or the motor M2. In other words, it can be said that the clutches 30, 230, 330, 430 are not required for the upper rolls 4, 104, 204, 304, 404 and the lower rolls 6, 106, 206, 306, 406 that are not driven to rotate by the motor M1 and/or the motor M2 (including the rotational driving via a chain).

The present embodiment shows an example for carrying out the present invention. Therefore, the present invention is not limited to the configuration of the present embodiment. Note that the corresponding relationship between each component of the present embodiment and each component of the present invention is shown below.

### REFERENCE SIGNS LIST

1 Veneer dewatering apparatus (Veneer dewatering apparatus)
2 Frame (Frame)
2a Base
2b Support wall
2c Support wall
4 Upper roll (First roll)
4a
6 Lower roll (Second roll)
20 Rotating shaft (Shaft)
20a Groove
22 Narrow roll
24 Narrow roll
26 Stopper (Connecting unit, Urging unit)
30 Clutch (Connecting unit)
32 Circular plate (Circular plate, First circular plate, Second circular plate)
32a Shaft insertion hole
32b Projection
34 Friction plate (Friction plate, First friction plate, Second friction plate, Third friction plate, Fourth friction plate, Fifth friction plate, Sixth friction plate)
34a Hole
40 Cylinder (Cylinder, First cylinder, Second cylinder)
40a Shaft insertion hole
41a Recess
41b Recess
46 Elastic cylindrical member (elastic cylindrical member, first elastic cylindrical member, second elastic cylindrical member)
90 Pipe
100 Veneer dewatering apparatus (Veneer dewatering apparatus)
104 Upper roll (First roll)
106 Lower roll (Second roll)
122 Narrow roll
140 Cylinder (Cylinder, First cylinder, Second cylinder)
141a Recess
141b Recess
142 Cover (Connecting unit, Urging unit)
200 Veneer dewatering apparatus (Veneer dewatering apparatus)
204 Upper roll (First roll)
206 Lower roll (Second roll)
222 Narrow roll
230 Clutch (Connecting unit)
232 Hub (Cylindrical hub, First cylindrical hub, Second cylindrical hub)
232a Shaft insertion hole
232b Groove
234 Brake shoe (friction member, First friction member, Second friction member)
234a friction material (Friction material)
240 Cylinder (Cylinder, First cylinder, Second cylinder)
241a Recess
241b Recess
242 Cover
300 Veneer dewatering apparatus (Veneer dewatering apparatus)
304 Upper roll (First roll)
306 Lower roll (Second roll)
320 Rotating shaft (Shaft)
320b Axial flow path (Connecting unit, Urging unit, Fluid passage)
320c Radial flow path (Connecting unit, Urging unit, First urging unit, Second urging unit, First radial through-hole)
322 Narrow roll
330 Clutch (Connecting unit)
332 Hub (Cylindrical hub, First cylindrical hub, Second cylindrical hub)
332a Shaft insertion hole
332b Groove
333 Stepped hole (Urging unit, first urging unit, Second urging unit, Second radial through-hole)
333a Larger hole
333b Smaller hole
334 Brake shoe (Friction member, First friction member, Second friction member)
334a Friction material (friction material)
334b Projection
400 Veneer dewatering apparatus (Veneer dewatering apparatus)
404 Upper roll (First roll)
406 Lower roll (Second roll)
422 Narrow roll
430 Clutch (Connecting unit)
432 Circular plate (Circular plate, First circular plate, Second circular plate)
432a Shaft insertion hole
432b Projecting piece
435a Pin (Projection, First projection)
435b Pin (Projection, Second projection)
440 Cylinder (Cylinder, First cylinder, Second cylinder)
441a Recess
441b Recess
443a Arcuate groove (Arcuate groove, first circular arc groove)
443b Arcuate groove (Arcuate groove, Second circular arc groove)
M1 Motor (Rotation driving unit)
M2 Motor (Rotation driving unit)
CL Axis
VP Virtual plane
CP Predetermined point (Predetermined point)
Dmin Distance between outer peripheral surfaces
t Thickness of veneer
tc Thickness dimension of clutch
dpr Depth of recess 41a, 41b, 141a, 241a
SPR1 Coil spring (Connecting unit, Urging unit, First urging unit, Second urging unit, Elastic body)
P Pump (Connecting unit, Urging unit, Fluid supply source)
SPR2 Coil spring (Urging unit, First urging unit, Second urging unit)

1. A veneer dewatering apparatus for removing water from a veneer, the apparatus comprising:
a frame;
a first roll rotatably supported by the frame;
a second roll rotatably supported by the frame and disposed parallel to the first roll at a distance smaller than a thickness of the veneer from the first roll; and
a rotation driving unit configured to drive to rotate at least one of the first and second rolls, wherein
the first and second rolls, at least one of which is driven by the rotation driving unit, each include a shaft rotatably supported by the frame, a cylinder disposed coaxially with the shaft on the outer periphery of the shaft, an elastic cylindrical member arranged integrally on the outer periphery of the cylinder and coaxially with the shaft, and a connecting unit positioned in a power transmission path between the shaft and the cylinder, and wherein
the connecting unit is configured to connect the shaft and the cylinder to rotate them integrally when the elastic cylindrical member contacts the veneer in a first state, and release the connection between the shaft and the cylinder to rotate them relative to each other when the elastic cylindrical member contacts the veneer in a second state.

2. The veneer dewatering apparatus according to claim 1, wherein
the connecting unit includes a circular plate supported by the shaft to be rotatable with the shaft, a friction plate facing the circular plate, wherein at least a part of the friction plate is arranged in the cylinder to be rotatable with the cylinder, and a pressing unit configured to press the friction plate against the circular plate.

3. The veneer dewatering apparatus according to claim 2, wherein
the friction plate includes a first friction plate and a second friction plate, the first and second friction plates, respectively, disposed axially on both sides of the shaft with respect to the circular plate, and
the pressing unit is configured to press at least one of the first and second friction plates directly against the circular plate.

4. The veneer dewatering apparatus according to claim 3, wherein
the cylinder includes at least a first cylinder and a second cylinder, the first and second cylinders being arranged in series axially of the shaft and restrained from moving axially of the shaft,
the elastic cylindrical member includes a first elastic cylindrical member and a second elastic cylindrical member, the first and second elastic cylindrical members being, respectively, arranged integrally with outer peripheries of the first and second cylinders,
the first friction plate is disposed in the first cylinder, and
the second friction plate is disposed in the second cylinder.

5. The veneer dewatering apparatus according to claim 2, wherein
the cylinder includes at least a first cylinder and a second cylinder, the first and second cylinders being arranged in series axially of the shaft and restrained from moving axially of the shaft,
the elastic cylindrical member includes a first elastic cylindrical member and a second elastic cylindrical member, the first and second elastic cylindrical members being, respectively, arranged integrally with outer peripheries of the first and second cylinders,
the circular plate includes a first circular plate and a second circular plate,
the friction plate includes a third friction plate and a fourth friction plate, respectively, disposed axially on both sides of the shaft with respect to the first circular plate, and includes a fifth friction plate and a sixth friction plate, respectively, disposed axially on both sides of the shaft with respect to the second circular plate,
the third and fourth friction plates are disposed in the first cylinder,
the fifth and sixth friction plates are disposed in the second cylinder, and
the pressing unit is configured to press at least one of the third and fourth friction plates directly against the first circular plate, and is configured to press at least one of the fifth and sixth friction plates directly against the second circular plate.

6. The veneer dewatering apparatus according to claim 1, wherein
the connecting unit includes: at least one friction member having an arc-shaped friction material, wherein the friction member is interposed between the shaft and the cylinder such that the friction material faces an inner peripheral surface of the cylinder; a cylindrical hub interposed between the friction member and the shaft, wherein the cylindrical hub is supported by the shaft to integrally rotate with the shaft and is connected to the friction member to integrally rotate with the friction member; and an urging unit disposed at least partially on the cylindrical hub and configured to urge the friction member radially outward so that the friction material contacts the inner peripheral surface of the cylinder.

7. The veneer dewatering apparatus according to claim 6, wherein
the urging unit is an elastic body disposed on the outer periphery of the cylindrical hub.

8. The veneer dewatering apparatus according to claim 6, wherein
the urging unit includes a fluid passage positioned through the shaft to extend axially of the shaft, at least one first radial through-hole that is open to face an inner peripheral surface of the friction member and extends through the shaft to the fluid passage, at least one second radial through-hole radially extending through the cylindrical hub to be in communication with the first radial through-hole, and a fluid supply source connected to the fluid passage so as to supply a fluid to the fluid passage.

9. The veneer dewatering apparatus according to claim 6, wherein
the cylinder includes at least a first cylinder and a second cylinder, the first and second cylinders being arranged in series axially of the shaft and restrained from moving axially of the shaft,
the elastic cylindrical member includes a first elastic cylindrical member and a second elastic cylindrical member, the first and second elastic cylindrical members being, respectively, arranged integrally with the outer peripheries of the first and second cylinders,
the friction member includes a first friction member interposed between the shaft and the first cylinder and a second friction member interposed between the shaft and the second cylinder,
the cylindrical hub includes a first cylindrical hub interposed between the shaft and the first friction member and a second cylindrical hub interposed between the shaft and the second friction member, and
the urging unit includes a first urging unit and a second urging unit, wherein the first urging unit is disposed at least partially on the first cylindrical hub and configured to urge the first friction member radially outward, and the second urging unit is disposed at least partially on the second cylindrical hub and configured to urge the second friction member radially outward.

10. The veneer dewatering apparatus according to claim 1, wherein
the cylinder has a circular arc groove on its surface facing axially of the shaft,
the connecting unit includes a circular plate supported by the shaft to be rotatable with the shaft and having a projection extending axially of the shaft so as to be engageable with the circular arc groove, and an urging unit disposed in the circular arc groove and configured to urge the circular plate in a rotational direction of the shaft via the projection.

11. The veneer dewatering apparatus according to claim 10, wherein
the cylinder includes at least a first cylinder and a second cylinder, the first and second cylinders being arranged in series axially of the shaft and restrained from moving axially of the shaft,
the elastic cylindrical member includes a first elastic cylindrical member and a second elastic cylindrical member, the first and second elastic cylindrical members being, respectively, arranged integrally with the outer peripheries of the first and second cylinders,
the circular arc groove includes a first circular arc groove disposed on the first cylinder and a second circular arc groove disposed on the second cylinder to face the first circular arc groove,
the projection includes a first projection extending axially of the shaft so as to be engageable with the first circular arc groove, and a second projection extending axially of the shaft in the direction away from the first projection so as to be engageable with the second circular arc groove, and
the urging unit includes a first urging unit and a second urging unit, wherein the first urging unit is disposed in the first circular arc groove and configured to urge the circular plate via the first projection in the rotation direction of the shaft, and the second urging unit is disposed in the second circular arc groove and configured to urge the circular plate via the second projection in the rotation direction of the shaft.

12. The veneer dewatering apparatus according to claim 4, wherein
the first and second rolls each have at least the first and second cylinders and first and second elastic cylindrical members that are arranged integrally on the outer peripheries of the first and second cylinders, respectively,
the first and second elastic cylindrical members of each of the first and second rolls have a substantially Z-shape cross section, on one side with respect to the axis of the first and second elastic cylindrical members, when cut along a virtual plane passing through the axis of the first and second elastic cylindrical members, and
the first and second rolls are arranged such that first cast shadows of the first and second elastic cylindrical members of the first roll on the virtual plane is in point symmetry, with respect to a predetermined point on the virtual plane, with second cast shadows of the first and second elastic cylindrical members of the second roll on the virtual plane.

13. The veneer dewatering apparatus according to claim 5, wherein
the first and second rolls each have at least the first and second cylinders and first and second elastic cylindrical members that are arranged integrally on the outer peripheries of the first and second cylinders, respectively,
the first and second elastic cylindrical members of each of the first and second rolls have a substantially Z-shape cross section, on one side with respect to the axis of the first and second elastic cylindrical members, when cut along a virtual plane passing through the axis of the first and second elastic cylindrical members, and
the first and second rolls are arranged such that first cast shadows of the first and second elastic cylindrical members of the first roll on the virtual plane is in point symmetry, with respect to a predetermined point on the virtual plane, with second cast shadows of the first and second elastic cylindrical members of the second roll on the virtual plane.

14. The veneer dewatering apparatus according to claim 9, wherein
the first and second rolls each have at least the first and second cylinders and first and second elastic cylindrical members that are arranged integrally on the outer peripheries of the first and second cylinders, respectively,
the first and second elastic cylindrical members of each of the first and second rolls have a substantially Z-shape cross section, on one side with respect to the axis of the first and second elastic cylindrical members, when cut along a virtual plane passing through the axis of the first and second elastic cylindrical members, and
the first and second rolls are arranged such that first cast shadows of the first and second elastic cylindrical members of the first roll on the virtual plane is in point symmetry, with respect to a predetermined point on the virtual plane, with second cast shadows of the first and second elastic cylindrical members of the second roll on the virtual plane.

15. The veneer dewatering apparatus according to claim 11, wherein
the first and second rolls each have at least the first and second cylinders and first and second elastic cylindrical members that are arranged integrally on the outer peripheries of the first and second cylinders, respectively,
the first and second elastic cylindrical members of each of the first and second rolls have a substantially Z-shape cross section, on one side with respect to the axis of the first and second elastic cylindrical members, when cut along a virtual plane passing through the axis of the first and second elastic cylindrical members, and
the first and second rolls are arranged such that first cast shadows of the first and second elastic cylindrical members of the first roll on the virtual plane is in point symmetry, with respect to a predetermined point on the virtual plane, with second cast shadows of the first and second elastic cylindrical members of the second roll on the virtual plane.

16. A veneer dewatering method for removing water from a veneer, using a veneer dewatering apparatus including:
a frame;
a first roll rotatably supported by the frame;
a second roll rotatably supported by the frame and arranged parallel to the first roll at a distance smaller than a thickness of the veneer from the first roll; and
a rotation driving unit configured to drive to rotate at least one of the first and second rolls, wherein
the first and second rolls, at least one of which is driven by the rotation driving unit, each include a shaft rotatably supported by the frame, a cylinder disposed coaxially with the shaft on the outer periphery of the shaft, and an elastic cylindrical member arranged integrally on the outer periphery of the cylinder and coaxially with the shaft, the method comprising:
connecting the shaft to the cylinder to cause the shaft and the cylinder to rotate integrally when the elastic cylindrical member contacts the veneer in a first state, and
releasing the connection between the shaft and the cylinder to cause the shaft and the cylinder to rotate relative to each other when the elastic cylindrical member contacts the veneer in a second state, so that the water in the veneer is dewatered.
